(19) United States
(12) Patent Application Publication
(10) Pub. No.: US 2010/0226149 A1
(43) Pub. Date: Sep. 9, 2010

(54) POWER-SUPPLY CONTROL DEVICE AND POWER-SUPPLY APPARATUS THEREWITH

(75) Inventor: Hiroshi Masumoto, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/628,278

(22) Filed: Dec. 1, 2009

(30) Foreign Application Priority Data
Mar. 3, 2009 (JP) 2009-49403
Jun. 24, 2009 (JP) 2009-149785

(51) Int. Cl. H02M 3/335

(52) U.S. Cl. 363/20

(57) ABSTRACT

An embodiment of the invention provides a converter power-supply apparatus that is efficiently operable for a wide-range load. A power-supply control device controls a boost converter. The boost converter includes a basic switching circuit, an expansion switching circuit that is connected in parallel with the basic switching circuit. A control circuit supplies a control signal to the basic and the expansion switching circuit through a first and a second signal line, respectively. A detecting unit detects a voltage and/or a current in a predetermined point of the boost converter. A comparison circuit compares a detected value with a reference value and supplies a first signal when a load is relatively heavy, a second signal when the load is relatively light. A control signal switch connects the second signal line when receiving the first signal, and disconnects the second signal line when receiving the second signal.

### CROSS REFERENCE TO RELATED APPLICATIONS

This application is based upon and claims the benefit of priority from prior Japanese Patent Application No. 2009-49403, filed on Mar. 3, 2009, and No. 2009-149785, filed on Jun. 24, 2009 the entire contents of which are incorporated herein by reference.

### BACKGROUND OF THE INVENTION

1. Field of the Invention

The present invention relates to a power-supply control device and a power-supply apparatus therewith, for example, to a power-supply control device that performs PFC control and a converter power-supply apparatus therewith.

2. Background Art

Recently, the number of kinds of a necessary power supply is increased with development of various electronic devices. On the other hand, it is said that an increase in energy consumption accelerates deterioration of global environment, particularly warming temperature caused by CO₂ emission, and energy conservation and high efficiency of an electronic device become a problem that should be dealt with.

Therefore, a switching regulator that is more efficient than a Zener diode or a linear regulator is generally used in a power circuit of the electronic device in which the energy conservation and high efficiency are demanded. Examples of the well-known switching regulator include a boost converter, a step-down converter, and a boost and step-down converter.

The switching regulator is widely used as described above. A capacitor input type rectifying/smoothing circuit is used in many electronic devices such as home electronics in which a commercial alternating-current source is used, a large amount of currents are passed only in a period the capacitor is charged. Therefore, from the viewpoint of the commercial alternating-current source side, a current waveform of the electronic device does not become a sine wave, but the current waveform includes many harmonic components.

Not only a noise problem is generated by the harmonic components, but also the harmonic components possibly have a harmful influence on a commercial power source or other device connected to the commercial power source when the harmonic components return to the commercial power source side. In addition, there is generated a problem in that a large amount of reactive powers are generated by largely lowering a power factor (cosφ).

In order to solve the problems, generally a control circuit that improves the power factor, that is, a PFC (Power Factor Correction) control circuit is used in the converter power-supply apparatus. The PFC control circuit performs on/off control of a switch of a switching circuit such that the current waveform of the electronic device becomes similar to a voltage waveform of an alternating-current source as much as possible, and such that a phase of the current waveform of the electronic device is matched with a phase of the voltage waveform of the alternating-current source. Then, an output of the switching circuit is smoothed by a smoothing capacitor. A filter that removes the harmonic components is inserted in a line that connects the switching circuit to the commercial alternating-current source.

Therefore, the harmonic component can be reduced to improve power factor.

An international regulation is being promoted for devices having the power consumption of 75 W or more such that introduction of the PFC control circuit is standardized.

A method for operating the PFC control is roughly classified into three modes, that is, a Continuous Conduction Mode (CCM), a Discontinuous Conduction Mode (DCM), and a Critical Conduction Mode (CRM). Each mode has the following characteristic.

In the continuous conduction mode, the switching is performed to the switch of the switching circuit before the current passed through a coil of the switching circuit becomes zero. The switching is performed by forcedly turning on and off the switch at a timing of a predetermined frequency of an OSC circuit disposed in the PFC control circuit. A current detector monitors the current passed through the coil of the switching circuit, and feedback control is performed based on the monitoring result to change a duty ratio of a control signal as needed.

The boost converter type PFC control circuit in which the continuous conduction mode is adopted turns on the switch while the current is passed through the coil and diode of the switching circuit. Therefore, because the current waveform becomes relatively smooth, advantageously the boost converter type PFC control circuit in which the continuous conduction mode is adopted can be used in the electronic device having the relatively large power. However, because a reverse recovery current is passed through the diode of the switching circuit, disadvantageously the large noise is generated from the diode and heat is easily generated in the diode.

On the other hand, in the discontinuous conduction mode (or critical conduction mode), the switching is not performed at the timing of the OSC circuit. That is, the current detector detects the current passed through the coil, and the switch is turned on at the timing at which the detected current becomes zero. Then the switch is turned off at proper timing such that the current passed through the coil is within a predetermined range proportional to the commercial power source voltage, and such that the output voltage at the power-supply apparatus does not deviate from a predetermined value.

Because the boost converter type PFC control circuit in which the discontinuous conduction mode is adopted turns on the switch after the current passed through the coil and diode of the switching circuit becomes zero, the current waveform becomes discontinuous to increase a ripple. Therefore, disadvantageously the boost converter type PFC control circuit in which the discontinuous conduction mode is adopted is not suitable to the electronic device having the relatively large power. However, the reverse recovery current is not passed through the diode and the boost converter type PFC control circuit in which the discontinuous conduction mode is adopted has a relatively simple circuit, so that advantageously the boost converter type PFC control circuit in which the discontinuous conduction mode is adopted is suitable to the electronic device having the small power.

In the critical conduction mode, the switch is turned on at the same time as the current passed through the coil and diode becomes zero. Because the current falls in zero only for a second, it is said that the critical conduction mode is a special mode of the discontinuous conduction mode. In the critical conduction mode, a time integral value of the current becomes the maximum in the discontinuous conduction mode. Therefore, the critical conduction mode becomes most efficient operation in the mode discontinuous conduction mode. Frequently the critical conduction mode is used.

Thus, generally the boost converter type PFC control circuit in which the continuous conduction mode is adopted is used in the device having the relatively large power (for example, 200 W to 300 W or more), and the boost converter type PFC control circuit in which the discontinuous conduction mode or the critical conduction mode is adopted is used in the device having the relatively small power.

Recently, as a space-saving electric product typified by a flat screen television becomes widespread, a strong need for a compact power-supply apparatus arises than ever before. In order to implement the compact power-supply apparatus, it is necessary to physically reduce dimensions of components such as the coil. In addition, it is necessary to configure a circuit in which heat is easily dissipated. The following two reasons are cited as the necessity of the circuit in which the heat is easily dissipated.

1) A heat dissipation measure becomes difficult as a spatial restriction is increased with the compact power-supply apparatus.

2) The difficult heat dissipation measure possibly becomes the problem with the heat generation of the diode when the continuous conduction mode is adopted for the device having the relatively large power.

When the critical conduction mode is adopted, the problem with the heat generation of the diode is substantially avoided although there is a condition that the critical conduction mode is adopted within a noise restricting range. However, for the critical conduction mode, as the power is increased, the ripple of the discontinuous current is increased to increase the noise. A rating of the coil of the switching circuit and a rating of a capacitor provided on the output side of the switching circuit are also increased. Therefore, the power-supply apparatus is inevitably enlarged.

Attention is focused on an interleaved PFC control as the means for solving the technical problems described above. In the interleave PFC control, the switching circuits of plural systems are prepared, the switching of the switches of the switching circuits is alternately performed such that the phases of the switching do not overlap one another. For example, in the boost converter that is operated in the critical conduction mode, the switching circuit is divided into two systems to reduce the current passed through each switching circuit to half, so that the rating of the coil can be decreased. Although the number of coils is increased, a volume occupied by the coils can be reduced as a whole because the volume per coil is largely reduced. Because a combined current of the switching circuits becomes smooth like the continuous conduction mode, the noise generation can be suppressed even for the large power.

In the interleave PFC control, the switching circuits of plural systems can be provided to reduce the volume of the coils as a whole. The noise and heat of the diode can be reduced by operating the switching circuit in the discontinuous conduction mode (or the critical conduction mode), and the combined current having the small ripple can be obtained by alternately operating the switching circuits.

Many documents already report the advantage of the interleave PFC control. For example, Japanese Patent No. 3480201 and Japanese Patent Application Laid-Open No. 2006-187140 disclose a technique, in which an interleave system of a switching converter is applied to the PFC control to deal with the large power while the critical conduction mode or the discontinuous conduction mode is adopted. U.S. Pat. Nos. 6,091,233 and 6,690,589 also disclose examples of the feature of the interleave system.

The current ripple exists in the output of the switching circuit even if any one of three operating methods (CCM, DCM, and CRM) concerning the PFC control is adopted. Therefore, it is necessary that the smoothing capacitor connected to the output terminal of the switching circuit deals with not a power computed from an average value of the current, but a power computed from a peak value of the current. When this requirement is not satisfied, a load applied to the smoothing capacitor instantaneously and iteratively exceeds a permissible amount of the smoothing capacitor, which results in a breakage of the smoothing capacitor or a significant deterioration of a lifetime of the smoothing capacitor.

As described above, it is necessary that the smoothing capacitor deals with the power computed from the peak value of the current, which causes the problem in that the smoothing capacitor is hardly miniaturized.

For example, in order to solve the technical problem, U.S. Pat. No. 5,565,761 proposes a technique, in which control is performed such that the boost converter type PFC control circuit and a PWM (Pulse Width Modulation) control circuit provided as a stage subsequent to the boost converter type PFC control circuit are synchronizes using the same oscillator and alternately operated, thereby decreasing the current ripple of the smoothing capacitor.

### SUMMARY OF THE INVENTION

According to a first aspect of the invention, a power-supply control device that controls a boost converter, the boost converter including a basic switching circuit, an expansion switching circuit that is connected in parallel with to the basic switching circuit, and a capacitor that smoothes output voltages of the basic switching circuit and the expansion switching circuit, the power-supply control device includes a control circuit that respectively supplies a control signal to the basic switching circuit and the expansion switching circuit through a basic switching circuit signal line and an expansion switching circuit signal line, a switch of the basic switching circuit and a switch of the expansion switching circuit being turned on and off by the control signal; a detecting unit that detects a voltage and/or a current in at least one of an input point of the boost converter, an input point of the basic switching circuit, an input point of the expansion switching circuit, and an output point of the boost converter; a comparison circuit that compares a value detected by the detecting unit with a reference value, the comparison circuit supplying a first signal when a load connected to an output terminal of the boost converter is not lower than a predetermined amount, the comparison circuit supplying a second signal when the load is lower than the predetermined amount; and a control signal switch that is provided in the expansion switching circuit signal line, the control signal switch connecting the expansion switching circuit signal line when receiving the first signal, the control signal switch disconnecting the expansion switching circuit signal line when receiving the second signal.

According to a second aspect of the invention, a power-supply control device that turns on and off a first switch and a second switch to control a boost converter and a second switching circuit, the boost converter including a first switching circuit that has the first switch and a capacitor that smoothes an output voltage at the first switching circuit, the second switching circuit having the second switch, the second switching circuit being series-connected to the boost converter, the second switching circuit receiving an output of the capacitor, the power-supply control device includes a PFC control circuit that performs on/off control of the first switch such that the first switching circuit performs a power factor improving operation in a discontinuous conduction mode or a critical conduction mode; and a PWM control circuit that performs on/off control of the second switch to perform PWM control of the second switching circuit, the PWM control circuit turning on the second switch using a signal supplied from the PFC control circuit when the PFC control circuit turns off the first switch, whereby part of electric energy released from the first switching circuit is caused to flow in the second switching circuit, the PWM control circuit turning off the second switch to decrease the current flowing in the second switching circuit when an input current to the second switching circuit exceeds a reference value, the reference value being determined according to an output voltage at the second switching circuit.

According to a third aspect of the invention, a power-supply control device that performs on/off control of a first switch and a second switch to control a boost converter, the boost converter including a first switching circuit that has the first switch, a second switching circuit that has the second switch, the second switching circuit being connected in parallel with the first switching circuit, and a capacitor that smoothes outputs of the first and second switching circuits, the power-supply control device includes a PFC control circuit that performs the on/off control of the first switch such that the first switching circuit performs a power factor improving operation in a discontinuous conduction mode or a critical conduction mode; and a PWM control circuit that performs the on/off control of the second switch to perform PWM control of the second switching circuit, the PWM control circuit turning on the second switch using a signal supplied from the PFC control circuit when the PFC control circuit turns off the first switch, the PWM control circuit turning off the second switch when an input current to the second switching circuit exceeds a reference value, thereby decreasing a current flowing in the second switching circuit, the reference value being determined according to an output voltage at the boost converter, the PWM control circuit stopping the on/off control of the second switch when a load connected to the output terminal of the boost converter is lower than a predetermined amount.

### BRIEF DESCRIPTION OF THE DRAWINGS

FIG. 1 illustrates a configuration of a converter power-supply apparatus according to a first embodiment of the invention;

FIG. 2 illustrates an example of a comparison circuit in the converter power-supply apparatus of the first embodiment;

FIG. 3 illustrates a configuration of a converter power-supply apparatus according to a second embodiment of the invention;

FIG. 4 illustrates an example of a comparison circuit in the converter power-supply apparatus of the second embodiment;

FIG. 5 illustrates a configuration of a converter power-supply apparatus according to a third embodiment of the invention;

FIG. 6 illustrates an example of a comparison circuit in the converter power-supply apparatus of the third embodiment;

FIG. 7 illustrates a configuration of a converter power-supply apparatus according to a fourth embodiment of the invention;

FIG. 8 is a timing chart illustrating an operation of the converter power-supply apparatus of the fourth embodiment;

FIG. 9 illustrates a configuration of a converter power-supply apparatus according to a fifth embodiment of the invention;

FIG. 10 is a timing chart illustrating an operation of the converter power-supply apparatus of the fifth embodiment;

FIG. 11 illustrates a configuration of a converter power-supply apparatus according to a sixth embodiment of the invention; and

FIG. 12 is a timing chart illustrating an operation of the converter power-supply apparatus of the sixth embodiment.

### DESCRIPTION OF THE EMBODIMENTS

How the inventor made the invention is described before embodiments of the invention are described.

Recently it is necessary to introduce the PFC control circuit due to the regulation of the harmonic noise against the power supply used in the electronic device. As described above, the interleave PFC control has various advantages such that a balance between the large power and the compactness is established. However, because the plural switching circuits are always operated, a switching loss is inevitably increased compared with the case in which the interleave system is not used when the small load is applied to the converter power supply, which results in a problem in that the efficiency is lowered. Even if the loss is slightly generated for a single piece of the electronic device, the influence of the electronic device on the environment is not negligible when the number of low-efficiency electronic devices is increased. Therefore, the need for the power supply having the high efficiency arises irrespective of the load amount of the power supply.

The electric power saving measure during the light load is not described in Japanese patent No. 3480201, Japanese Patent Application Laid-Open No. 2006-187140, and U.S. Pat. Nos. 6,091,233, 6,690,589, and 5,565,761. That is, although the interleave system in which plural switching circuits are used is described, how to perform the electric power saving measure during the light load is not described.

Because the PFC control is still used in the future for the electronic device in which commercial alternating-current source is used, there is the need of implementing the PFC control power supply in which the power loss is decreased as much as possible, and there is the need of incorporating the power supply in the electronic device. That is, it is necessary to implement the converter power supply having the good efficiency in the wide range of load, and it is necessary that the environmental load is decreased by promoting the electric power saving particularly during the light load of the electronic device.

The invention is made based on the unique technical recognition of the inventor to provide a power-supply control device having the good efficiency in the wide range of load and the converter power-supply apparatus therewith.

A switching method in the power-supply apparatus of a comparative example will be described below.

For example, it is assumed that a power-supply apparatus includes a first switching circuit and a second switching circuit that is series-connected to a stage subsequent to the first switching circuit through a smoothing capacitor. The first switching circuit and the smoothing capacitor constitute a boost converter. The first switching circuit boosts a pulsating voltage that is rectified and smoothed by a rectifier, and the PFC control is performed to the first switching circuit. The second switching circuit steps down a direct-current voltage supplied from the boost converter to a predetermined direct-current voltage, and the PWM control is performed to the second switching circuit.

Both switching signals of the first switching circuit and second switching circuit are produced using a CLK signal supplied from an oscillator. Because the switching signal of the second switching circuit is synchronized with a reverse phase of the switching signal of the first switching circuit, a switch of the second switching circuit is turned on at the timing at which a switch of the first switching circuit is turned off. That is, the switch of the second switching circuit is turned on at the timing at which the switch of the first switching circuit is turned off to charge the smoothing capacitor. Because part of the current, which flows originally in the smoothing capacitor, flows in the second switching circuit to suppress a charge flowing in the smoothing capacitor, the voltage rise is suppressed at both ends of the smoothing capacitor.

In the power-supply apparatus of the comparative example, the switch of the second switching circuit is turned off at the timing at which the switch of the first switching circuit is turned on. That is, the switch of the second switching circuit is turned off to cut off the current flowing in the second switching circuit at the timing at which the switch of the first switching circuit is turned on to cut off the current flowing in the smoothing capacitor from the first switching circuit. Therefore, the current flowing out from the smoothing capacitor to the second switching circuit is suppressed. As a result, the voltage drop is suppressed at both the ends of the smoothing capacitor.

In the power-supply apparatus of the comparative example, the voltage rise and voltage drop are suppressed at both the ends of the smoothing capacitor, that is, the voltage ripple is suppressed at both the ends of the smoothing capacitor. As a result, the rating of the smoothing capacitor can be decreased to implement the compact smoothing capacitor.

However, the power-supply apparatus of the comparative example has the following problem.

Because the switching signal of the second switching circuit is synchronized with the reverse phase of the switching circuit of the first switching circuit, the operation of the PWM control circuit is largely restricted by the PFC control circuit of the preceding stage. Therefore, the flexible PWM control is hardly performed, and the power-supply apparatus hardly exhibits the sufficient function.

Additionally, because the power-supply apparatus of the comparative example is operated in the continuous conduction mode, the reverse recovery current of the diode is hardly decreased, and the heat generation is increased. Recently, there is the need for the high-efficiency electronic device in order to decrease the environmental load. Therefore, the intrinsically difficult electrical power saving measure causes a large problem.

The invention is made based on the unique technical recognition of the inventor to solve the problem as described in the following embodiments.

Hereinafter, a power-supply control device and a power-supply apparatus therewith according to the present invention will be described more specifically with reference to the drawings.

A power-supply apparatus according to first to third embodiments includes plural switching circuits connected in parallel, and the number of operated switching circuits is dynamically increased and decreased according to the load amount.

The converter power-supply apparatus of the first embodiment includes two switching circuits, and a determination whether the switching circuits are operated in parallel is made based on result of comparison of various monitoring values of the switching circuit with a reference value.

The converter power-supply apparatus of the second embodiment includes three switching circuits, two reference values are provided for one monitoring value, and the number of operated switching circuits is increased and decreased more finely.

The converter power-supply apparatus of the third embodiment includes a DC-DC converter connected to a stage subsequent to the converter power-supply apparatus, the number of operated switching circuits is increased and decreased by referring to not only the various monitoring values of the switching circuits but also the current passed through the DC-DC converter.

A power-supply apparatus according to fourth to fifth embodiments includes two switching circuits connected in series, and a power-supply apparatus according to a sixth embodiment includes two switching circuits connected in parallel.

A component having an equal function is designated by the same numeral, and the detailed description will not be repeated.

### FIRST EMBODIMENT

A converter power-supply apparatus according to a first embodiment of the invention will be described below. The converter power-supply apparatus of the first embodiment includes two switching circuits, only one of the switching circuits is operated during the light load, and both the switching circuits are operated during the heavy load. That is, the number of operated switching circuits is dynamically increased and decreased according to the load.

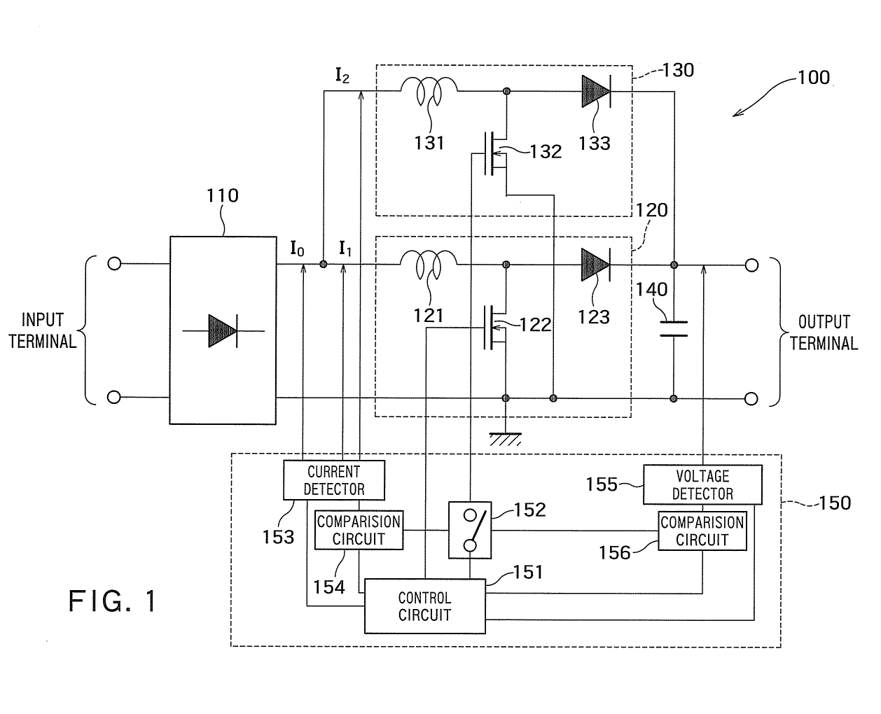

FIG. 1 illustrates a configuration of a converter power-supply apparatus 100 of the first embodiment. Referring to FIG. 1, the converter power-supply apparatus 100 includes a rectifier 110, a switching circuit 120 (basic switching circuit), a switching circuit 130 (expansion switching circuit), a capacitor 140, and a power-supply control device 150.

A commercial alternating-current source (not illustrated) is connected to an input terminal. A load (not illustrated) is connected to an output terminal. For example, the load is a DC-DC converter that steps down a boosted direct-current voltage to a desired voltage (for example, 30 V).

Each component will be described below.

The rectifier 110 includes a full-wave rectifying circuit. The rectifier 110 causes a voltage externally applied from the commercial alternating-current source to pulsate, and the rectifier 110 supplies the pulsating voltage to the switching circuits 120 and 130.

The switching circuit 120 includes a coil 121, a switch 122, and a diode 123. The switching circuit 120 is a basic switching circuit that is normally operated.

The switching circuit 130 includes a coil 131, a switch 132, and a diode 133. The switching circuit 130 is an expansion switching circuit that is operated only when a large load is applied to the power-supply apparatus 100.

Preferably, the switches 122 and 132 are provided in the form of a MOS Field Effect Transistors (MOSFET), and a control circuit 151 performs on/off control of the switches 122 and 132.

As illustrated in FIG. 1, the switching circuits 120 and 130 are connected in parallel, and the switching circuits 120 and 130 are connected to an output of the rectifier 110. The switching circuits 120 and 130 play both a role as a boost circuit and a role of improving a power factor by shaping a current waveform.

The capacitor 140 is a smoothing capacitor that is connected to output ends of the switching circuits 120 and 130, and accumulates the charges obtained by totalizing outputs of the switching circuits 120 and 130.

The switching circuits 120 and 130 and the capacitor 140 constitute a boost converter. The boost converter boosts a pulsating voltage, which is produced by the rectifier 110 based on the commercial alternating-current source, to a desired direct-current voltage. For example, a pulsating voltage having a peak voltage of 141 (=100√2) V is boosted to a direct-current voltage of 300 V to 400 V.

As illustrated in FIG. 1, the power-supply control device 150 includes a control circuit 151, a control signal switch 152, a current detector 153, two comparison circuits 154 and 156, and a voltage detector 155. Preferably, the power-supply control device 150 is provided in the form of an integrated circuit (IC). In order to perform PFC control, the power-supply control device 150 may have a function of detecting an output voltage at the rectifier 110 and a function of comparing the detected output voltage and an output current of the current detector 153.

The control circuit 151 performs feedback control such that a voltage detected by the voltage detector 155 does not drop out from a predetermined voltage. The control circuit 151 supplies a control signal to the switching circuit 120 and the switching circuit 130 through a signal line (a basic switching circuit signal line and an expansion switching circuit signal line). The control circuit 151 transmits control signals of the switches 122 and 132, and the control circuit 151 turns on and off the switches 122 and 132 at proper timing to perform the PFC control. More specifically, the control circuit 151 performs the on/off control of the switches 122 and 132 based on the current detected by the current detector 153 such that a waveform of a current (combined current) obtained by combining a current of the coil 121 of the switching circuit 120 and a current of the coil 131 of the switching circuit 130, that is, a waveform of a current fed into the boost converter becomes similar to a voltage waveform of the alternating-current source as much as possible while a phase of the waveform of the current fed into the boost converter is matched with a phase of the voltage waveform of the alternating-current source.

The control signal switch 152 is connected to outputs of the comparison circuit 154 and comparison circuit 156. The control signal switch 152 is disposed between the control circuit 151 and a gate terminal of the switch 132 in the switching circuit 130. The control signal switch 152 connects and disconnects a signal line of the control signal for the switch 132, which is supplied from the control circuit 151, based on the outputs of the comparison circuits 154 and 156. More specifically, the control signal switch 152 disconnects the signal line of the control signal for the switch 132 when receiving, for example, an L-level signal from the comparison circuit 154 or 156. When the control signal switch 152 disconnects the signal line, the switching circuit 130 does not receive the PFC control signal, and thus the operation of the switching circuit 130 is stopped. Preferably, the control signal switch 152 is provided in the form of a semiconductor circuit such as a tristate buffer.

As illustrated in FIG. 1, the current detector 153 detects a current (total current) I₀ supplied from the rectifier 110, a current I₁ passed through the coil 121 of the switching circuit 120, and a current 1₂ passed through the coil 131 of the switching circuit 130. Not only the detected currents are transmitted to the control circuit 151 and used in the PFC control, but also the detected currents are transmitted to the comparison circuit 154 and used in the on/off operation of the control signal switch 152. Note that it is not necessary to transmit all the currents I₀, I₁, and I₂ detected by the current detector 153 to the comparison circuit 154. One or two of the currents I₀, I₁, and I₂ may be transmitted to the comparison circuit 154 as long as the currents I₀, I₁, and I₂ are correlated with one another by previously defining a circuit constant between the switching circuit 120 and the switching circuit 130 or a timing at which the switches 122 and 132 are controlled.

As illustrated in FIG. 1, the comparison circuit 154 is connected to the control circuit 151, the control signal switch 152, and the current detector 153. The comparison circuit 154 compares a current obtained from the current detector 153 with a current (reference current) arbitrarily defined by the control circuit 151. That is, the comparison circuit 154 determines whether the current obtained from the current detector 153 is smaller than the reference current. When the current obtained from the current detector 153 is smaller than the reference current (a load is smaller than a predetermined amount), the comparison circuit 154 supplies an L-level signal to the control signal switch 152. When the current obtained from the current detector 153 is larger than the reference current (the load is larger than the predetermined amount), the comparison circuit 154 supplies an H-level signal to the control signal switch 152.

Note that whether the current value supplied from the current detector 153 is set larger or smaller according to the load may arbitrarily be determined by a circuit configuration of the current detector 153. For example, the current detector 153 may be configured such that the current value supplied from the current detector 153 is set larger than the reference current when the load is smaller than the predetermined amount, and such that the current value is set smaller than the reference current when the load is larger than the predetermined amount.

The voltage detector 155 detects a voltage generated at both ends of the capacitor 140. The voltage detector 155 performs feedback control such that the voltage at the output terminal of the converter power-supply apparatus 100 becomes a predetermined value. In addition, in the first embodiment, the voltage detector 155 has also a function of monitoring the voltage compared to a reference voltage (described later).

The comparison circuit 156 is connected to the control circuit 151, the control signal switch 152, and the voltage detector 155. The comparison circuit 156 compares the voltage obtained from the voltage detector 155 with a voltage (reference voltage) arbitrarily defined by the control circuit 151. That is, the comparison circuit 156 determines whether the voltage obtained from the voltage detector 155 is smaller than the reference voltage. When the voltage obtained from the voltage detector 155 is larger than the reference voltage (the load is smaller than a predetermined amount), the comparison circuit 156 supplies the L-level signal to the control signal switch 152. When the voltage obtained from the voltage detector 155 is smaller than the reference voltage, the comparison circuit 156 supplies the H-level signal to the control signal switch 152. Note that whether the voltage value supplied from the voltage detector 155 is set larger or smaller according to the load may arbitrarily be determined by a circuit configuration of the current detector 155 like with the current detector 153.

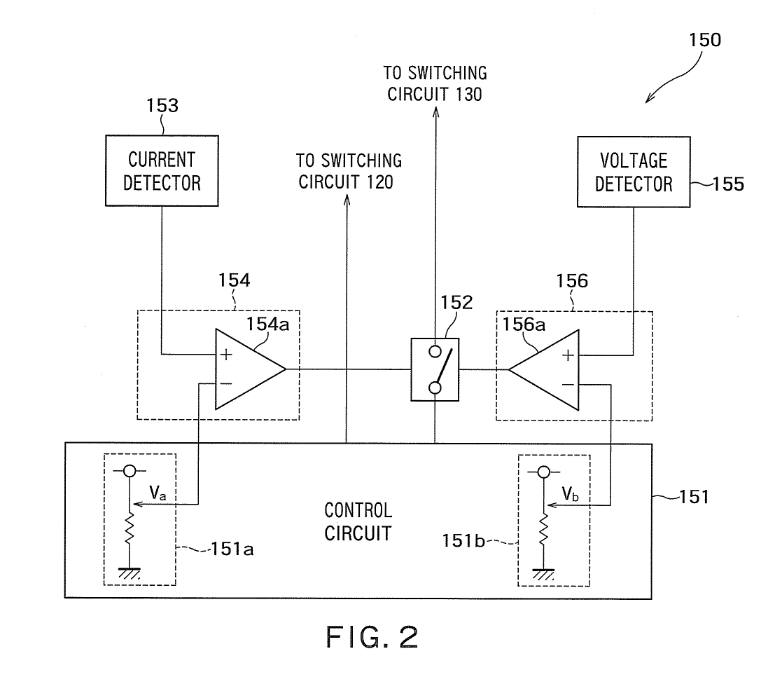

An example of a specific configuration of the comparison circuits 154 and 156 will be described with reference to FIG. 2. As illustrated in FIG. 2, the comparison circuit 154 and the comparison circuit 156 include a comparator 154a and a comparator 156a, respectively.

A voltage into which the current detected by the current detector 153 is converted is fed into a positive input terminal of the comparator 154a. Note that the voltage conversion may be performed by either the current detector 153 or the comparison circuit 154.

A voltage Vₐ generated by the voltage generating circuit 151a in the control circuit 151 is fed into a negative input terminal of the comparator 154a. For example, the voltage Vₐ may be equal to a voltage into which the reference current is converted.

The voltage supplied from the voltage detector 155 is fed into a positive input terminal of the comparator 156a.

A voltage V_{b} generated by the voltage generating circuit 151b in the control circuit 151 is fed into a negative input terminal of the comparator 156a. For example, the voltage V_{b} may be equal to the reference voltage.

The comparators 154a and 156a supply the L-level signal when the voltage fed into the positive input terminal is larger than the voltage fed into the negative input terminal. On the other hand, the comparators 154a and 156a supply the H-level signal when the voltage fed into the positive input terminal is smaller than the voltage fed into the negative input terminal.

An operation of the converter power-supply apparatus 100 of the first embodiment will be described below.

The converter power-supply apparatus 100 acts as the converter power-supply apparatus having the well-known PFC control circuit. That is, the converter power-supply apparatus 100 has the function of causing the waveform of the combined current described above to become similar to the voltage waveform of the alternating-current source as much as possible and the converter power-supply apparatus 100 has the function of matching the phase of the waveform of the combined current with the phase of the voltage waveform of the alternating-current source.

Further, in the converter power-supply apparatus 100 of the first embodiment, the comparison circuit 154 (comparison circuit 156) determines whether the current detected by the current detector 153 (voltage detector 155) is smaller than the reference current (reference voltage). The on/off control of the control signal switch 152 is performed based on the determination result. The switching circuit 130 is stopped when the control signal switch 152 is turned off, and the switching circuit 130 is operated under the control of the control circuit 151 when the control signal switch 152 is turned on. Therefore, only the switching circuit 120 is operated when the load is smaller than the predetermined value, and both the switching circuit 120 and the switching circuit 130 are operated when the load is larger than the predetermined value.

That is, the switching circuit 130 is stopped, when the current detected by the current detector 153 is smaller than the reference current, or when voltage detected by the voltage detector 155 is larger than the reference voltage. For example, when the load connected to the output terminal of the converter power-supply apparatus 100 is smaller than a maximum output of the switching circuit 120, the unnecessary switching circuit 130 is stopped and only the switching circuit 120 is operated. Therefore, a switching loss caused by operating the switching circuit 130 during the light load may largely be reduced. Note that the switching loss may further be reduced by simultaneously adopting a method for lowering switching rates of the switches 122 and 132 to decrease the number of switching times.

Two methods for controlling the switching circuits 120 and 130 will be described below.

In the first method, the control circuit 151 does not include a circuit (OSC circuit) that is oscillated at a predetermined frequency. In this method, an amount of current passed through each of the switching circuits 120 and 130 is previously determined. The switches 122 and 132 of the switching circuits 120 and 130 are turned on at the time each switching circuit current detected by the current detecting circuit 153 becomes smaller than a predetermined current amount, and the switches 122 and 132 are turned off at the time each switching circuit current becomes larger than the predetermined current amount. The switch 122 of the switching circuit 120 is turned off while the switch 132 of the switching circuit 130 is turned on, and the switch 122 of the switching circuit 120 is turned on while the switch 132 of the switching circuit 130 is turned off. Thus, the time the switches 122 and 132 of the switching circuits 120 and 130 are turned on and off is arbitrarily determined, so that the converter power-supply apparatus 100 may efficiently be operated by controlling the switching circuits 120 and 130.

Note that when the predetermined current amount is set to zero, the switching circuits 120 and 130 are operated in the discontinuous conduction mode or the critical conduction mode, which allows a reverse recovery current not to be passed through the diodes 123 and 133 of the switching circuits 120 and 130. However, when the predetermined current amount is set to zero, because a current ripple is increased to generate a large amount of noises, it is not always necessary to set the predetermined current amount to zero. That is, it is only necessary to establish a balance between the power saving of the converter power-supply apparatus 100 and the noise suppression, and the current predetermined amount may be set to any value.

In the second method, the control circuit 151 includes the OSC circuit that is oscillated at the predetermined frequency. Usually the frequency of the OSC circuit is set to about 70 kHz. In this method, the switches 122 and 132 are forcedly turned on and off irrespective of the amount of current passed through each of the switching circuits 120 and 130. Because the commercial alternating-current source has the frequency of about 50 Hz, a period in which the switches 122 and 132 are turned on and off is sufficiently larger than the frequency of the commercial alternating-current source, and the current passed through each of the switching circuits 120 and 130 does not become zero. Therefore, the converter power-supply apparatus 100 is operated in a continuous conduction mode.

Incidentally, if the OSC circuit has a fixed frequency, there is a risk of hardly reducing the noise generated from the control circuit 151 since a frequency component of the noise includes a multiple number of the frequency. Therefore, the frequency of the OSC circuit is arbitrarily fluctuated in a range of, for example, 70 kHz±5 kHz to diffuse the frequency component of the noise generated from the control circuit 151, thereby decreasing a peak value of the noise to reduce the noise. The range of the frequency fluctuation is not limited to the above-described range, but the range of the frequency fluctuation may arbitrarily be set.

Preferably, even if the frequency is arbitrarily fluctuated, the switch 122 of the switching circuit 120 is turned off as much as possible while the switch 132 of the switching circuit 130 is turned on, and the switch 122 of the switching circuit 120 is turned on as much as possible while the switch 132 of the switching circuit 130 is turned off. Therefore, the converter power-supply apparatus 100 may efficiently be operated.

The converter power-supply apparatus of the first embodiment is described above.

In the first embodiment, the on/off control is performed to the control signal switch 152 based on the outputs of the comparison circuits 154 and 156. Alternatively, if sufficient accuracy is obtained by using one of the comparison circuits 154 and 156, the other comparison circuit may be omitted, and the on/off control may be performed based only on the output of the comparison circuit 154 or 156.

It is not necessary that the current detector 153 detect all the currents I₀, I₁, and I₂. The detected current may arbitrarily be selected according to the required accuracy. For example, any two currents in the currents I₀, I₁, and I₂ may be detected while the remaining current is estimated by computation. In another example, assuming that the current passed through the switching circuit 120 is substantially equal to the current passed through the switching circuit 130, one of the current I₁ and the current I₂ is monitored, and the other current value may be estimated from the monitored value. The assumption may hold when the switching circuits 120 and 130 are synchronously operated with the substantially same duty ratio while the circuit constants of the switching circuits 120 and 130 are substantially equal to each other. For example, the assumption may hold when the switching circuits 120 and 130 are alternately operated with control signals whose phases are different from each other by about 180°.

As described above, in the first embodiment, the currents are detected at the input point of the boost converter, the voltage is detected at the output point. Because which the current or the voltage is detected is arbitrarily selected on circuit design, the voltage detector may be used instead of the current detector 153, and the current detector may be used instead of the voltage detector 155.

The power-supply control device 150 may include a voltage detector (not illustrated) that detects the voltage to which the full wave rectification is performed by the rectifier 110. The voltage detector is used to detect a malfunction of the rectifier 110.

The voltage generating circuits 151a and 151b are not limited to the configurations of FIG. 2, but a configuration having another circuit based on the current may be used as long as the basic operation is identical to those of the voltage generating circuits 151a and 151b.

In the first embodiment, the voltage generating circuits 151a and 151b are provided in the control circuit 151.

Alternatively, the voltage generating circuits 151a and 151b may be provided in the comparison circuits 154 and 156 or the voltage generating circuits 151a and 151b may be provided outside the power-supply control device 150.

The H-level signal and the L-level signal may reversely be provided. That is, the comparators 154a and 156a may supply the H-level signal when the input signal of the positive input terminal is larger than the input signal of the negative input terminal, the comparators 154a and 156a may supply the L-level signal when the input signal of the positive input terminal is smaller than the input signal of the negative input terminal. The control signal switch 152 may be turned off when receiving the H-level signal, and the control signal switch 152 may be turned on when receiving the L-level signal.

When the reference voltage and the reference current are set to previously determined values, possibly converter power-supply apparatuses increase and decrease the switching circuits according to the different load amounts in manufacturing a plurality of converter power-supply apparatuses. This is because a characteristic amount of each element (such as a coil and a capacitor) constituting the converter power-supply apparatus is varied within a specification range.

Preferably, in order to prevent the problem, the current value detected by the current detector 153 and the voltage value detected by the voltage detector 155 are measured while the load whose amount is well known is connected to the output terminal of the converter power-supply apparatus 100. The reference current and the reference voltage are set based on the detected current value and the detected voltage value.

As described above, in the first embodiment, the converter power-supply apparatus that has the good efficiency in the wide range of load may be provided by dynamically increasing and decreasing the number of choppers (switching circuits) according to the load. The converter power-supply apparatus of the first embodiment may also be efficiently operated for the electronic device in which the load is largely changed. Particularly, the electrical power saving may be promoted to decrease the environmental load when the light load is applied to the electronic device, that is, when the electronic device is in a standby state and the like.

### SECOND EMBODIMENT

A converter power-supply apparatus according to a second embodiment of the invention will be described below. The converter power-supply apparatus of the second embodiment differs from the converter power-supply apparatus of the first embodiment in the number of switching circuits and the number of reference values. The converter power-supply apparatus of the second embodiment includes three switching circuits, and two reference voltages and two reference currents are provided, so that the number of operated switching circuits may arbitrarily changed within a range of one to three according to the load to perform the highly efficient operation.

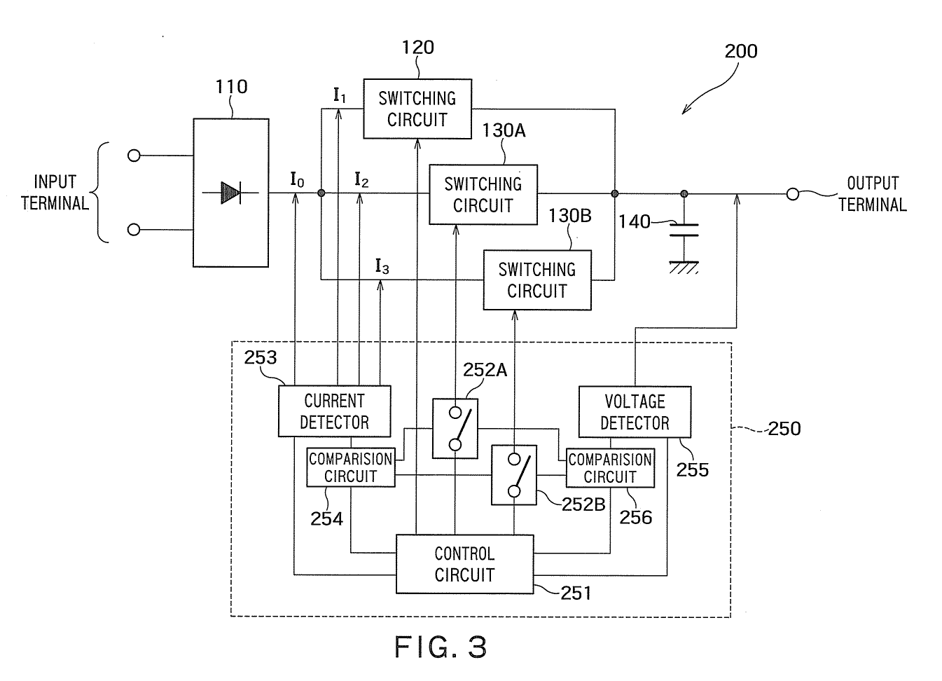

FIG. 3 illustrates a configuration of a converter power-supply apparatus 200 of the second embodiment. Referring to FIG. 3, the converter power-supply apparatus 200 includes the rectifier 110, three switching circuits 120, 130A, and 130B, the capacitor 140, and a power-supply control device 250. The switching circuits 130A and 130B are an expansion switching circuit, and the switching circuits 130A and 130B have the configuration similar to that of the switching circuit 130.

As illustrated in FIG. 3, the power-supply control device 250 includes a control circuit 251, two control signal switches 252A and 25213, a current detector 253, two comparison circuits 254 and 256, and a voltage detector 255. Preferably, the power-supply control device 250 is provided in the form of an integrated circuit (IC).

The control circuit 251 performs the feedback control such that the voltage detected by the voltage detector 255 does not drop out from a predetermined voltage. The control circuit 251 transmits the control signals to the switches of the switching circuits 120, 130A, and 130B, and the control circuit 251 turns on and off the switches at proper timing to perform the PFC control.

As illustrated in FIG. 3, both the control signal switches 252A and 252B are connected to outputs of the comparison circuits 254 and 256. The control signal switch 252A (252B) is disposed between the control circuit 251 and the gate terminal of the switch in the switching circuit 130A (130B). The control signal switch 252A (25213) connects and disconnects the signal line of the control signal, which is supplied from the control circuit 251, based on the outputs of the comparison circuits 254 and 256.

As illustrated in FIG. 3, the current detector 253 detects the current (total current) I₀ supplied from the rectifier 110, the current I₁ passed through the switching circuit 120, a current I₂ passed through the switching circuit 130A, and a current I₃ passed through the switching circuit 130B. Not only the detected currents are transmitted to the control circuit 251 and used in the PFC control, but also the detected currents are transmitted to the comparison circuit 254 and used in the on/off operation of the control signal switches 252A and 252B. Note that it is not necessary to transmit all the currents I₀, I₁, and I₂ detected by the current detector 253 to the comparison circuit 254, but at least one of the currents I₀, I₁, I₂, and I₃ may be transmitted to the comparison circuit 254 as long as the currents I₀, I₁, I₂, and I₃ are correlated with one another.

As illustrated in FIG. 3, both the outputs of the comparison circuits 254 and 256 are supplied to the control signal switches 252A and 252B.

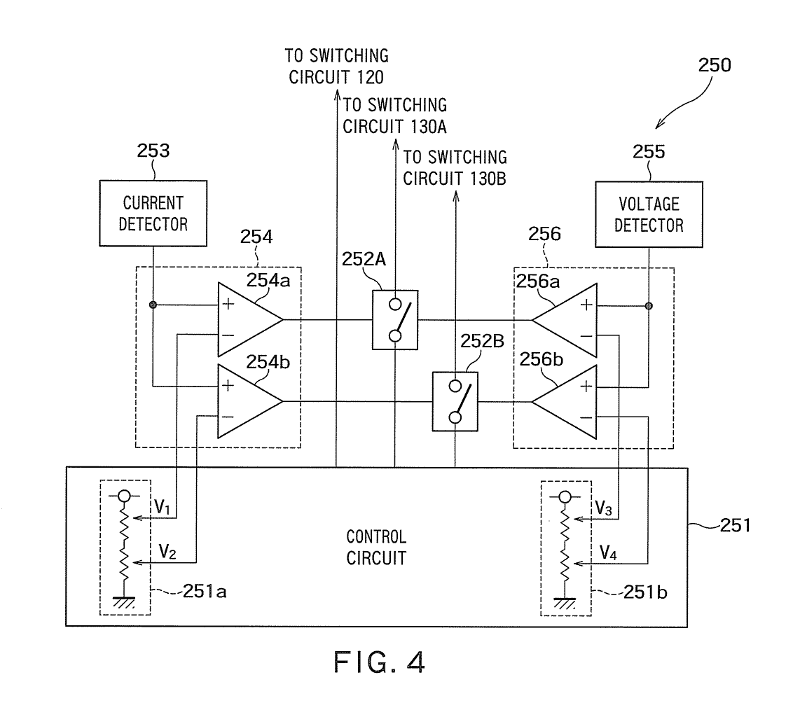

The voltage detector 255 detects the voltage at both ends of the capacitor 140. An example of a specific configuration of the comparison circuits 254 and 256 will be described with reference to FIG. 4. As illustrated in FIG. 4, the comparison circuit 254 includes a comparator 254a and a comparator 254b, and the comparison circuit 256 includes a comparator 256a and a comparator 256b. The comparators have the functions similar to those of the comparators 154a and 154b of the first embodiment.

A voltage into which the current detected by the current detector 253 is converted is fed into positive input terminals of the comparators 254a and 254b. Note that the voltage conversion may be performed by either the current detector 253 or the comparison circuit 254.

A voltage V₁ generated by a voltage generating circuit 251a in the control circuit 251 is fed into a negative input terminal of the comparator 254a. A voltage V₂ (<V₁) generated by the voltage generating circuit 251a in the control circuit 251 is fed into a negative input terminal of the comparator 254b.

A voltage supplied from the voltage detector 255 is fed into positive input terminals of the comparators 256a and 256b.

A voltage V₃ generated by a voltage generating circuit 251b in the control circuit 251 is fed into a negative input terminal of the comparator 256a. A voltage V₄ (<V₃) generated by the voltage generating circuit 251b in the control circuit 251 is fed into a negative input terminal of the comparator 256b.

The comparators 254a, 254b, 256a, and 256b supply the L-level signal for turning off the control signal switches 252A and 252B when the voltages fed into the positive input terminals of the comparators 254a, 254b, 256a, and 256b are larger than the voltages fed into the negative input terminal of the comparators 254a, 254b, 256a, and 256b. On the other hand, the comparators 254a, 254b, 256a, and 256b supply the H-level signal for turning on the control signal switches 252A and 252B when the voltages fed into the positive input terminals of the comparators 254a, 254b, 256a, and 256b are smaller than the voltages fed into the negative input terminal of the comparators 254a, 254b, 256a, and 256b.

With this configuration, the comparison circuit 254 (256) compares the current value (voltage value) detected by the current detector 253 (voltage detector 255) with the reference values correlated to the control signal switches 252A and 252B. As a result of the comparison, the signal for turning on the control signal switch is supplied to the control signal switch corresponding to a predetermined amount when the load on the converter power-supply apparatus 200 is larger than the predetermined amount, and the signal for turning off the control signal switch is supplied to the control signal switch corresponding to the predetermined amount when the load is smaller than the predetermined amount.

The description will be made more specifically. The switching circuits 120, 130A, and 130B are operated as follows by a voltage V supplied from the current detector 253. It is assumed that the current detector 253 supplies the larger voltage with decreasing load.

(i) For V>V₁, only the switching circuit 120 is operated.

(ii) For V₂<V<V₁, the switching circuits 120 and 130A are operated.

(iii) For V<V₂, the switching circuit 120, the switching circuit 130A, and the switching circuit 130B are operated.

Similarly, the switching circuits 120, 130A, and 130B are operated as follows by a voltage V′ supplied from the voltage detector 255. It is assumed that the voltage detector 255 supplies the larger voltage with decreasing load.

(i) For V′>V₃, only the switching circuit 120 is operated.

(ii) For V₄<V′<V₃, the switching circuits 120 and 130A are operated.

(iii) For V′<V₄, the switching circuits 120, 130A, and 130B are operated.

Therefore, the converter power-supply apparatus 200 may arbitrarily change the number of operated switching circuits within the range of one to three according to the load connected to the output terminal.

The PFC control operation of the converter power-supply apparatus 200 is similar to that of the first embodiment.

A converter power-supply apparatus including at least four switching circuits may be provided by applying the configuration of the second embodiment.

As described above, the effect similar to that of the first embodiment is obtained in the second embodiment. Further, the number of operated switching circuits is more finely increased and decreased according to the load, which allows the converter power-supply apparatus to be operated more efficiently.

### THIRD EMBODIMENT

A converter power-supply apparatus according to a third embodiment of the invention will be described below. The converter power-supply apparatus of the third embodiment has a point different from the converter power-supply apparatuses of the first and second embodiments. That is, the converter power-supply apparatus of the third embodiment includes a step-down converter connected to a stage subsequent to the boost converter, and the current passed through the step-down converter is monitored to increase and decrease the number of operated switching circuits. Therefore, the load amount may correctly be recognized to efficiently operate the power-supply apparatus.

A converter power-supply apparatus 300 of the third embodiment will be described in detail.

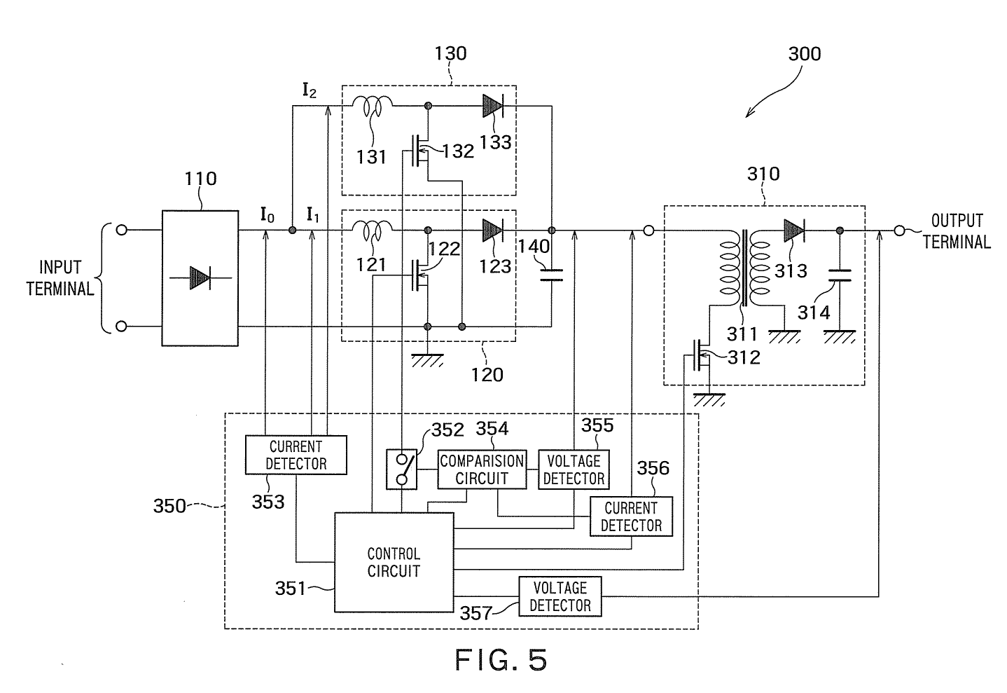

FIG. 5 illustrates a configuration of a converter power-supply apparatus 300 of the third embodiment. Referring to FIG. 5, the converter power-supply apparatus 300 includes the rectifier 110, two switching circuits 120 and 130 that are connected in parallel, the capacitor 140, a flyback converter 310 that is connected behind the capacitor 140, and a power-supply control device 350.

The flyback converter 310 is an insulating type DC-DC converter that includes a transformer 311, a switch 312, a diode 313, and a capacitor 314 (smoothing capacitor). The flyback converter 310 steps down the output voltage at the boost converter, which includes the switching circuits 120 and 130 and the capacitor 140, to a desired voltage (for example, 30 V), and the flyback converter 310 supplies the stepped-down voltage to the output terminal.

The power-supply control device 350 will be described below. Referring to FIG. 5, the power-supply control device 350 includes a control circuit 351, a control signal switch 352, current detectors 353 and 356, a comparison circuit 354, and two voltage detectors 355 and 357. Preferably, the power-supply control device 350 is provided in the form of an integrated circuit (IC).

The control circuit 351 performs the feedback control such that the voltage detected by the voltage detector 355 does not drop out from a predetermined voltage. The control circuit 351 transmits the control signals of the switches 122 and 132 to turn on and off the switches 122 and 132 at proper timing, thereby performing the PFC control. The control circuit 351 transmits the control signal to the switch 312 of the flyback converter 310 to perform the PWM (Pulse Width Modulation) control such that the voltage detected by the voltage detector 357 does not drop out from a predetermined voltage.

As illustrated in FIG. 5, the control signal switch 352 is connected to the comparison circuit 354. The control signal switch 352 is disposed between the control circuit 351 and the gate terminal of the switch 132 in the switching circuit 130. The control signal switch 352 connects and disconnects the signal line of the control signal, which is supplied from the control circuit 351, based on the output of the comparison circuit 354.

As illustrated in FIG. 5, the current detector 353 detects the current (total current) I₀ supplied from the rectifier 110, the current I₁ passed through the coil 121 of the switching circuit 120, and a current I₂ passed through the coil 131 of the switching circuit 130. The detected currents are transmitted to the control circuit 351 and used in the PFC control.

The voltage detector 355 detects the voltage generated at both ends of the capacitor 140, and supplies the detected voltage to the control circuit 351 and the comparison circuit 354.

The current detector 356 detects the current supplied from the boost converter, that is, the current fed into the flyback converter 310, and an output of the current detector 356 is connected to the comparison circuit 354. Note that the current detector 356 may supply the detected current to the control circuit 351 as illustrated in FIG. 5.

The voltage detector 357 detects the output voltage at the flyback converter 310 to supply the detected voltage to the control circuit 351.

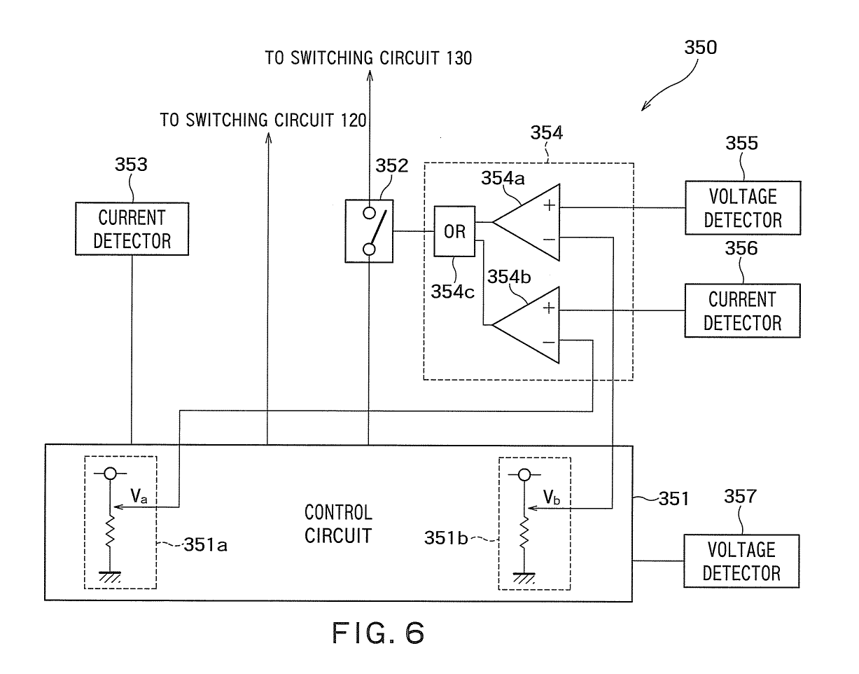

As illustrated in FIG. 5, the comparison circuit 354 is connected to the control circuit 351, the control signal switch 352, the voltage detector 355, and the current detector 356. An example of a specific configuration of the comparison circuit 354 will be described with reference to FIG. 6. Referring to FIG. 6, the comparison circuit 354 includes comparators 354a and 354b and an OR gate 354c. The comparators 354a and 354b have the functions similar to those of the comparators 154a and 154b of the first embodiment.

The voltage detected by the voltage detector 355 is fed into the positive input terminal of the comparator 354a, and the voltage V_{b} generated by the voltage generating circuit 351b in the control circuit 351 is fed into the negative input terminal of the comparator 354a.

The voltage into which the current supplied from the current detector 356 is converted is fed into the positive input terminal of the comparator 354b, and the voltage Vₐ generated by the voltage generating circuit 351a in the control circuit 351 is fed into the negative input terminal of the comparator 354b.

The outputs of the comparators 354a and 354b are fed into the OR gate 354c.

The output of the OR gate 354c is used to perform the on/off control of the control signal switch 352.

As apparent from the above configuration, the comparison circuit 354 compares the voltage detected by the voltage detector 355 with the reference voltage. The comparison circuit 354 also compares the current detected by the current detector 356 with the reference current. As a result, the comparison circuit 354 supplies the signal (L-level signal) for turning off the control signal switch 352, when the voltage detected by the voltage detector 355 is larger than the reference voltage and, at the same time, when the current detected by the current detector 356 is larger than the reference current.

In the third embodiment, the number of operated switching circuits is increased and decreased based on not only the output voltage at the boost converter but the current passed through the flyback converter. Therefore, the load amount may correctly be recognized even if the voltage detected by the voltage detector 355 is fluctuated by factors except for the fluctuation in load (for example, malfunction of the flyback converter 310).

The PFC control operation of the converter power-supply apparatus 300 is similar to that of the first embodiment.

A forward type converter may be used instead of the flyback converter 310. The flyback converter 310 is not limited to the step-down converter, but the boost converter and the boost and step-down converter may be used as the flyback converter 310.

The plural flyback converters 310 may be connected in parallel to the stage subsequent to the boost converter.

The number of switching circuits is not limited to two, but at least three switching circuits may be used.

As described above, in the third embodiment, as with the first and second embodiments, the converter power-supply apparatus that has the good efficiency in the wide range of load may be provided by dynamically increasing and decreasing the number of operated switching circuits according to the load. Particularly, the electrical power saving may be promoted to decrease the environmental load when the light load is applied to the electronic device, that is, when the electronic device is in the standby state and the like.

Further, according to the third embodiment, the load amount is correctly recognized. Accordingly, the operation may be performed more correctly and more efficiently.

### FOURTH EMBODIMENT

A converter power-supply apparatus according to a fourth embodiment of the invention will be described below. The converter power-supply apparatus of the fourth embodiment has a point different from the converter power-supply apparatuses of the comparative example described above. That is, the critical conduction mode (or discontinuous conduction mode) is adopted in the converter power-supply apparatus of the fourth embodiment, and the PWM control is performed to the subsequent switching circuit independently of the control of the preceding switching circuit.

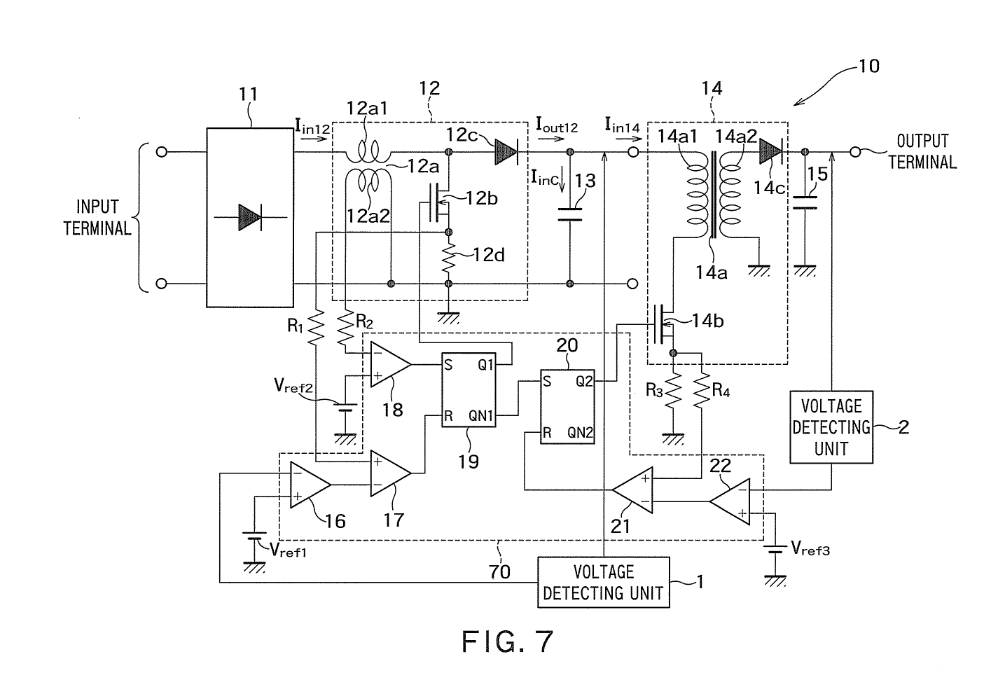

FIG. 7 illustrates a configuration of a converter power-supply apparatus 10 of the fourth embodiment. Referring to FIG. 7, the converter power-supply apparatus 10 includes a rectifier 11, a switching circuit 12, a capacitor 13, a switching circuit 14, a capacitor 15, and a power-supply control device 70.

The commercial alternating-current source (not illustrated) is connected to the input terminal of the converter power-supply apparatus 10, and the load (not illustrated) is connected to the output terminal. For example, the load is a DC-DC converter that steps down a boosted direct-current voltage to a desired voltage (for example, 30 V).

Each component of the converter power-supply apparatus 10 will be described below.

The rectifier 11 includes a full-wave rectifying circuit. The rectifier 11 causes the voltage applied from the external commercial alternating-current source to pulsate, and the rectifier 11 supplies the pulsating voltage to the switching circuit 12.

The switching circuit 12 includes a coil 12a, a switch 12b, a diode 12c, and a resistor 12d. The coil 12a includes a primary winding 12a1 and a secondary winding 12a2. For example, as illustrated in FIG. 7, the switch 12b is an n-type MOSFET.

The capacitor 13 is a smoothing capacitor that is connected to an output end of the switching circuit 12, and charges (electric energy) supplied from the switching circuit 12 is accumulated in the capacitor 13.

The switching circuit 12 and the capacitor 13 constitute the boost converter. The boost converter boosts the pulsating voltage produced by the rectifier 11 based on the commercial alternating-current source to the desired direct-current voltage. For example, the boost converter boosts the pulsating voltage having the peak voltage of 141 (=100√2) V to the direct-current voltage of 300 V to 400 V.

The switching circuit 14 is an insulating type DC-DC converter that includes a transformer 14a, a switch 14b, and a diode 14c. The transformer 14a includes a primary winding 14a1 and a secondary winding 14a2.

The switching circuit 14 is series-connected to the boost converter, which includes the switching circuit 12 and the capacitor 13. The switching circuit 14 steps down the output voltage at the boost converter to the desired voltage (for example, 30 V) to supply the stepped-down voltage to the output terminal of the converter power-supply apparatus 10.

The capacitor 15 is a smoothing capacitor that is connected to the output end of the switching circuit 14. That is, the capacitor 15 smoothes the output voltage at the switching circuit 14 while supplying electric energy to a circuit (not illustrated) connected to the output terminal of the converter power-supply apparatus 10.

Referring to FIG. 7, the power-supply control device 70 includes error amplifiers 16 and 22, current detecting comparators 17 and 21, a zero-current detecting comparator 18, and flipflops 19 and 20.

The error amplifier 16 amplifies and supplies a difference between inputs of a positive terminal and a negative terminal. The positive terminal of the error amplifier 16 is connected to a reference voltage Vref1. The voltage in which the output voltage at the switching circuit 12 (the voltage in which the voltage at both ends of the capacitor 13) is reduced by a voltage detecting unit 1 is fed into the negative terminal of the error amplifier 16. The voltage detecting unit 1 reduces the output voltage at the switching circuit 12 to a specification range (for example, 5 V or less) of the input terminal of the error amplifier 16 using a unit such as a resistance voltage divider.

The current detecting comparator 17 compares the voltage fed into the negative terminal with the voltage fed into the positive terminal. The current detecting comparator 17 supplies the H-level signal when the voltage at the positive terminal is larger than the voltage at the negative terminal, and the current detecting comparator 17 supplies the L-level signal when the voltage at the positive terminal is smaller than the voltage at the negative terminal. The signal supplied from the current detecting comparator 17 is fed into a reset terminal of the flipflop 19. The voltage into which the current passed through the switch 12b of the switching circuit 12 is converted is fed into the positive terminal of the current detecting comparator 17. The signal based on the output voltage at the error amplifier 16 is fed as the reference voltage into the negative terminal of the current detecting comparator 17. More specifically, in order to perform the power factor improving operation, the voltage fed into the negative terminal of the current detecting comparator 17 is a signal in which waveform information on the voltage supplied from the rectifier 11 is mixed in the output signal of the error amplifier 16. For example, the signal is obtained by multiplying the output of the error amplifier 16 and an output voltage waveform of the rectifier 11. The waveform of the current passed through the switching circuit 12 is maintained similar to the waveform of the output voltage at the rectifier 11 using the signal.

As apparent from the above configuration, the flipflop 19 is reset when the current passed through the switch 12b of the switching circuit 12 becomes the reference value or more. Note that the reference value depends on the output voltage at the switching circuit 12, and the reference value is decreased with increasing output voltage.

The output terminal of the zero-current detecting comparator 18 is connected to a set terminal of the flipflop 19. The positive terminal of the zero-current detecting comparator 18 is connected to a reference voltage Vref2. The negative terminal of the zero-current detecting comparator 18 is connected to the secondary winding 12a2 of the coil 12a through a resistor R2, and the voltage into which the current passed through the secondary winding 12a2 is converted is fed into the negative terminal of the zero-current detecting comparator 18. The zero-current detecting comparator 18 supplies the H-level signal to set the flipflop 19 when the current passed through the secondary winding 12a2 of the coil 12a becomes equal to or lower than a constant value determined by the reference voltage Vref2. The reference voltage Vref2 is a sufficiently small value. Therefore, the zero-current detecting comparator 18 supplies the H-level signal when the current passed through the coil 12a becomes substantially zero.

A Q1 terminal of the flipflop 19 is connected to the gate terminal of the switch 12b of the switching circuit 12. The switch 12b is turned on when the H-level signal is supplied from the Q1 terminal, and the switch 12b is turned off when the L-level signal is supplied from the Q1 terminal.

As apparent from the above configuration, the H-level signal is supplied from the Q1 terminal to turn on the switch 12b, when the current passed through the secondary winding 12a2 of the coil 12a is equal to or lower than the constant value determined by the reference voltage Vref2 of the zero-current detecting comparator 18, that is, when the current passed through the secondary winding 12a2 of the coil 12a becomes substantially zero. On the other hand, the L-level signal is supplied from the Q1 terminal to turn off the switch 12b, when the current passed through the switch 12b is larger than the reference value based on the output of the error amplifier 16. The control of the switching circuit 12 is power factor improving control called the critical conduction mode in which the necessity of the oscillator is eliminated. In the critical conduction mode, the reverse recovery current passed through the diode 12c is decreased. Therefore, the high-efficiency operation can be achieved.

A stage subsequent to the converter power-supply apparatus 10 of the fourth embodiment will be described below.

The switching control (PWM control) is performed to the switching circuit 14 using the output signal at a Q2 terminal of the flipflop 20.

The set terminal of the flipflop 20 is connected to a QN1 terminal of the flipflop 19. The flipflop 20 is set at the timing at which the output of the QN1 terminal becomes the H-level signal, that is, at the timing at which the output of the Q1 terminal becomes the L-level signal, and the H-level signal is supplied from the Q2 terminal. The Q2 terminal of the flipflop 20 is connected to the gate terminal of the switch 14b of the switching circuit 14. The switch 14b is turned on when the H-level signal is supplied from the Q2 terminal, and the switch 14b is turned off when the L-level signal is supplied from the Q2 terminal. Therefore, the switch 14b of the switching circuit 14 is turned on at the timing at which the switch 12b of the switching circuit 12 is turned off.

When the switch 14b of the switching circuit 14 is turned on to pass the current through the primary winding 14a1 of the transformer 14a, an electromotive force in a positive direction (forward direction of the diode 14c) is generated in the secondary winding 14a2, thereby charging the capacitor 15.

Control in which the switch 14b is turned on at the timing at which the switch 12b is turned off will be described from the viewpoint of the outflow and inflow of the electric energy. The switching circuit 12 accumulates the electric energy obtained from the output of the rectifier 11 in the coil 12a while the switch 12b is turned on. When the switch 12b is turned off, the electric energy accumulated in the coil 12a is emitted to the capacitor 13. The electric energy does not flow in the input of the switching circuit 14 if the switch 14b of the switching circuit 14 is turned off at this point, and thus the whole of the electric energy flowing in from the switching circuit 12 flows in the capacitor 13. However, in the fourth embodiment, because the switch 14b is turned on at the timing at which the switch 12b is turned off, the electric energy emitted from the switching circuit 12 flows in not only the capacitor 13 but the switching circuit 14. That is, part of the emitted electric energy is accumulated in the transformer 14a of the switching circuit 14. Because the electric energy accumulated in the capacitor 13 is decreased, the voltage rise becomes gentle at both ends of the capacitor 13. As used herein, the electric energy is equivalent to the charge.

Assuming that v(t) is the voltage at both ends of the capacitor 13, the following equation holds:

v(t)=q(t)/C=∫i(t)dt/C

where t is a time, q(t) is a charge accumulated in the capacitor 13, i(t) is a current flowing in the capacitor 13, and C is a capacity of the capacitor 13.

The time integration of the current i(t) is the charge q(t) accumulated in the capacitor 13. A change in voltage v(t) at both ends of the capacitor 13 is decreased as a change in current i(t) is decreased. That is, the ripple of the voltage at both ends of the capacitor 13 is decreased with decreasing current ripple.

Control in which the switch 14b of the switching circuit 14 is turned off will be described below.

The error amplifier 22 amplifies and supplies a difference between inputs of a positive terminal and a negative terminal. The positive terminal of the error amplifier 22 is connected to a reference voltage Vref3. The voltage in which the output voltage at the switching circuit 14 (the voltage at both ends of the capacitor 15) is reduced by a voltage detecting unit 2 is fed into the negative terminal of the error amplifier 22. The voltage detecting unit 2 reduces the output voltage at the switching circuit 14 to a specification range (for example, 5 V or less) of the input terminal of the error amplifier 22 using a unit such as a resistance voltage divider.

The current detecting comparator 21 compares the voltage fed into the negative terminal with the voltage fed into the positive terminal. The current detecting comparator 21 supplies the H-level signal when the voltage at the positive terminal is larger than the voltage at the negative terminal, and the current detecting comparator 21 supplies the L-level signal when the voltage at the positive terminal is smaller than the voltage at the negative terminal. The output signal of the current detecting comparator 21 is fed into a reset terminal of the flipflop 20. The voltage into which the current passed through the switch 14b of the switching circuit 14 is converted is fed into the positive terminal of the current detecting comparator 21. The output signal of the error amplifier 22 is fed as the reference voltage into the negative terminal of the current detecting comparator 21.

The Q2 terminal of the flipflop 20 is connected to the gate terminal of the switch 14b of the switching circuit 14. The switch 14b is turned on when the H-level signal is supplied from the Q2 terminal, and the switch 14b is turned off when the L-level signal is supplied from the Q2 terminal.

As apparent from the above configuration, the flipflop 20 is reset when the current passed through the switch 14b of the switching circuit 14 becomes the reference value or more. Note that the reference value depends on the output voltage at the switching circuit 14, and the reference value is decreased with increasing output voltage.

The L-level signal is supplied from the Q2 terminal of the flipflop 20 to turn off the switch 14b, thereby cutting off a primary-side current of the coil 14a. At this point, an electromotive force in a negative direction (reverse direction of the diode 14c) is generated on the secondary winding side of the transformer 14a. However, because the diode 14c cuts off the current, the capacitor 15 does not discharge toward the switching circuit 14. As seen above, the charging in the capacitor 15 is stopped by turning off the switch 14b.

In the fourth embodiment, as seen above, the timing at which the switch 14b is turned on may be matched with the timing at which the switch 12b is turned off without the oscillator in the comparative example.

Further, in the fourth embodiment, the timing at which the switch 14b is turned off is based on the output voltage at the switching circuit 14 and the current passed through the switch 14b, which means that the timing at which the switch 14b is turned off is independent of the control of the switching circuit 12. Therefore, the function of the PWM control may sufficiently be exerted. That is, stability of the output voltage may be improved by controlling the switching circuit 14 based on the voltage at both ends of the capacitor 15, and an overcurrent may be prevented from being passed through the switch 14b by controlling the switching circuit 14 based on the current passed through the switch 14b.

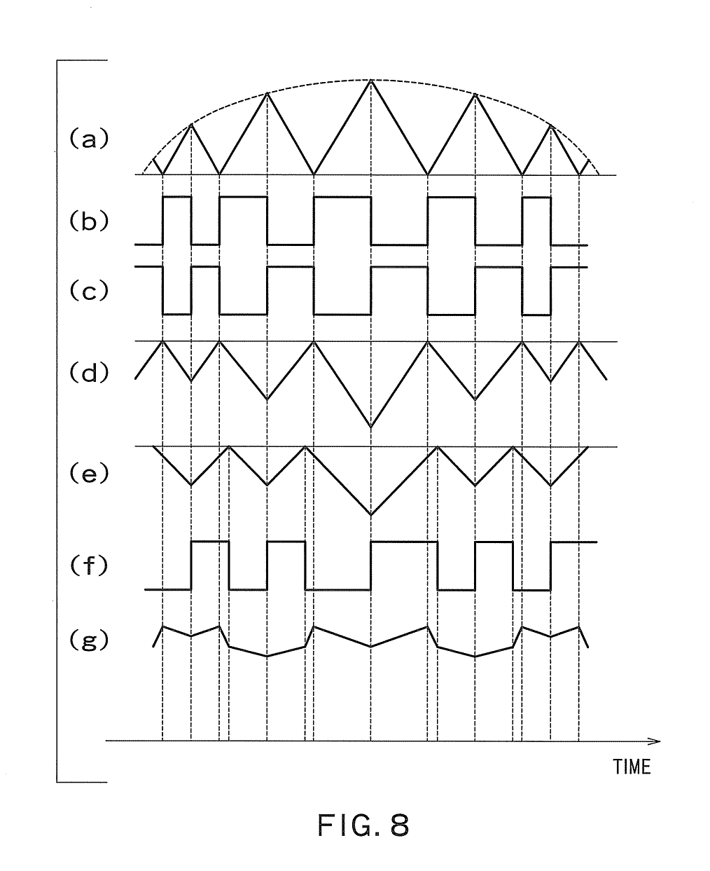

An operation of the converter power-supply apparatus 10 of the fourth embodiment will be described with reference to a timing chart of FIG. 8. FIG. 8 is a timing chart illustrating an operation of the converter power-supply apparatus 10.

FIG. 8(a) illustrates a waveform of a current Iin12 fed into the switching circuit 12.

FIG. 8(b) illustrates a waveform of a signal supplied from the Q1 terminal of the flipflop 19. As can be seen from FIGS. 8(a) and 8(b), the signal supplied from the Q1 terminal rises when the current Iin12 becomes zero (L-level signal→H-level signal), and the signal falls when the current Iin12 reaches a predetermined current value (waveform illustrated by a broken line of FIG. 8(a)) (H-level signal→L-level signal).

FIG. 8(c) illustrates a waveform of a signal supplied from the QN1 terminal of the flipflop 19. The signal supplied from the QN1 terminal is one in which the signal supplied from the Q1 terminal is inverted.

FIG. 8(d) illustrates a waveform of a current Iout12 supplied from the switching circuit 12.

FIG. 8(e) illustrates a waveform of a current Iin14 fed into the switching circuit 14.

FIG. 8(f) illustrates a waveform of a signal supplied from the Q2 terminal of the flipflop 20. As can be seen from FIGS. 8(b), 8(e) and 8(f), the signal supplied from the Q2 terminal rises when the signal supplied from the Q1 terminal falls, and the signal falls when the current Iin14 reaches a predetermined value.

FIG. 8(g) illustrates a waveform of a current Iinc fed into the capacitor 13. As can be seen from FIG. 8(g), in the waveform of the input current Iinc, the current ripple is decreased compared with the waveform of the current Iout12 of the switching circuit 12 of FIG. 8(d). The decrease in current ripple of the input current Iinc will be described in detail.

The input current Iinc of the capacitor 13 is given by the following equation:

Iinc=Iout12−Iin14

where Iout12 is the current supplied from the switching circuit 12 and Iin14 is the current fed into the switching circuit 14.

As described above, in the fourth embodiment, because the switch 14b of the switching circuit 14 is turned on at the timing at which the switch 12b of the switching circuit 12 is turned off, the phases of the currents Iout12 and Iin14 are substantially matched with each other. As can be seen from FIG. 8(g), the fluctuation in input current Iinc of the capacitor 13 is suppressed. Therefore, the rating of the capacitor 13 may be decreased to implement the compact capacitor 13. Further, an inrush current is decreased to reduce the load on the capacitor 13, so that a lifetime of the capacitor 13 may be lengthened.

As can be seen from FIGS. 8(d) and 8(e), there is a portion in which the two current waveforms (currents Iout12 and Iin14) are not strictly in-phase. This is because the control of the switching circuit 14 is independent of the control of the switching circuit 12. That is, the timing at which the switch 14b is turned off is independent of the switching circuit 12.

In the fourth embodiment, the first switching circuit 12 is operated in the critical conduction mode in which the necessity of the oscillator is eliminated, so that the problematic reverse recovery current passed through the diode 12c of the switching circuit 12 may significantly be decreased. Therefore, the efficiency of the converter power-supply apparatus may largely be improved.

In the fourth embodiment, as described above, the compactness and lengthened lifetime of the smoothing capacitor can be achieved by decreasing the voltage ripple generated at both ends of the smoothing capacitor. As a result, the compactness and lengthened lifetime of the power-supply apparatus may be achieved.

In addition, the PWM control is performed to the switching circuit at the subsequent stage independently of the switching circuit at the preceding stage. Therefore, the PWM control functions such as the stability of the output voltage and the prevention of the overcurrent can sufficiently be exerted.

Further, the reverse recovery current of the diode is suppressed by the critical conduction mode to obtain the high-efficiency converter power-supply apparatus.

### FIFTH EMBODIMENT

A converter power-supply apparatus 30 according to a fifth embodiment of the invention will be described below. The converter power-supply apparatus of the fifth embodiment has a point different from those of the fourth embodiment. That is, the condition that the switch of the switching circuit at the subsequent stage is added to prevent the overcurrent passed through the switching circuit and generation of acoustic noise caused by the rapid change in current passed through the coil in the start-up or the fluctuation in load.

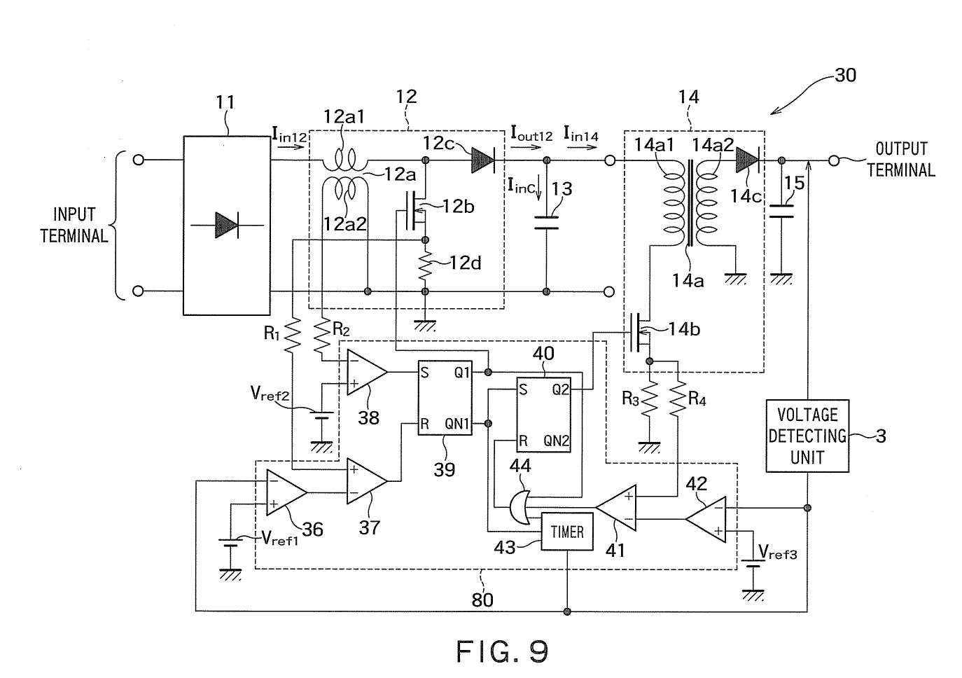

FIG. 9 illustrates a configuration of a converter power-supply apparatus 30 of the fifth embodiment. Referring to FIG. 9, the converter power-supply apparatus 30 includes the rectifier 11, the switching circuit 12, the capacitor 13, the switching circuit 14, the capacitor 15, and a power-supply control device 80.

As illustrated in FIG. 9, the power-supply control device includes error amplifiers 36 and 42, current detecting comparators 37 and 41, a zero-current detecting comparator 38, flipflops 39 and 40, a timer 43, and an OR gate 44.

The error amplifier 36 amplifies and supplies a difference between inputs of a positive terminal and a negative terminal. The voltage in which the output voltage at the switching circuit 14 (the voltage at both ends of the capacitor 15) is reduced by a voltage detecting unit 3 is fed into the negative terminal of the error amplifier 36. Note that the voltage detecting unit 3 reduces the output voltage at the switching circuit 14 to a specification range (for example, 5 V or less) of the input terminal of the error amplifier 36 using a unit such as a resistance voltage divider. The positive terminal of the error amplifier 36 is connected to the reference voltage Vref1.

The current detecting comparator 37 compares the voltage fed into the negative terminal with the voltage fed into the positive terminal. The current detecting comparator 37 supplies the H-level signal when the voltage at the positive terminal is larger than the voltage at the negative terminal, and the current detecting comparator 37 supplies the L-level signal when the voltage at the positive terminal is smaller than the voltage at the negative terminal. The output signal of the current detecting comparator 37 is fed into the reset terminal of the flipflop 39. The voltage into which the current passed through the switch 12b of the switching circuit 12 is converted is fed into the positive terminal of the current detecting comparator 37. The signal based on the output voltage at the error amplifier 36 is fed as the reference voltage into the negative terminal of the current detecting comparator 37. More particularly, as described in the fourth embodiment, the signal in which the waveform information on the voltage supplied from the rectifier 11 is mixed in the output signal of the error amplifier 36 is fed into the negative terminal of the current detecting comparator 37.

As apparent from the above configuration, the flipflop 39 is reset when the current passed through the switch 12b of the switching circuit 12 becomes the reference value or more. Note that the reference value depends on the output voltage at the switching circuit 12, and the reference value is decreased with increasing output voltage.

The output terminal of the zero-current detecting comparator 38 is connected to the set terminal of the flipflop 39. The positive terminal of the zero-current detecting comparator 38 is connected to the reference voltage Vref2. The negative terminal of the zero-current detecting comparator 38 is connected to the secondary winding 12a2 of the coil 12a through the resistor R2, and the voltage into which the current passed through the secondary winding 12a2 is converted is fed into the negative terminal of the zero-current detecting comparator 38. As known from the configuration, the zero-current detecting comparator 38 supplies the H-level signal to set the flipflop 39 when the current passed through the secondary winding 12a2 of the coil 12a becomes equal to or lower than a constant value determined by the reference voltage Vref2. The reference voltage Vref2 is a sufficiently small value. Therefore, the zero-current detecting comparator 38 supplies the H-level signal when the current passed through the coil 12a becomes substantially zero.

The Q1 terminal of the flipflop 39 is connected to the gate terminal of the switch 12b of the switching circuit 12 and the OR gate 44. The switch 12b is turned on when the H-level signal is supplied from the Q1 terminal, and is turned off when the L-level signal is supplied from the Q1 terminal.

As apparent from the above configuration, the H-level signal is supplied from the Q1 terminal to turn on the switch 12b, when the current passed through the secondary winding 12a2 of the coil 12a is equal to or lower than the constant value determined by the reference voltage Vref2 of the zero-current detecting comparator 38, that is, when the current passed through the secondary winding 12a2 of the coil 12a becomes substantially zero. On the other hand, the L-level signal is supplied from the Q1 terminal to turn off the switch 12b, when the current passed through the switch 12b is larger than the reference value based on the output of the error amplifier 36. As with the fourth embodiment, the control of the switching circuit 12 is the power factor improving control called the critical conduction mode. In the critical conduction mode, the reverse recovery current passed through the diode 12c is decreased. Therefore, the high-efficiency operation can be achieved.

In the fifth embodiment, unlike the fourth embodiment, not only the switching circuit 14 but the switching circuit 12 are controlled based on the output of the voltage detecting unit 3. Therefore, the circuit configuration of the converter power-supply apparatus 30 may be simplified to implement the compact converter power-supply apparatus 30.

A stage subsequent to the converter power-supply apparatus 30 of the fifth embodiment will be described below.

The switching control (PWM control) is performed to the switching circuit 14 using the output signal at the Q2 terminal of the flipflop 40.

The set terminal of the flipflop 40 is connected to the QN1 terminal of the flipflop 39. The flipflop 40 is set at the timing at which the output of the QN1 terminal becomes the H-level signal, that is, at the timing at which the output of the Q1 terminal becomes the L-level signal, and the H-level signal is supplied from the Q2 terminal. The Q2 terminal of the flipflop 40 is connected to the gate terminal of the switch 14b of the switching circuit 14. The switch 14b is turned on when the H-level signal is supplied from the Q2 terminal, and the switch 14b is turned off when the L-level signal is supplied from the Q2 terminal. Therefore, the switch 14b of the switching circuit 14 is turned on at the timing at which the switch 12b of the switching circuit 12 is turned off, so that the voltage ripple generated at both ends of the capacitor 13 may be decreased as described above in the fourth embodiment.

Control in which the switch 14b of the switching circuit 14 is turned off will be described below.

The error amplifier 42 amplifies and supplies a difference between inputs of a positive terminal and a negative terminal. The positive terminal of the error amplifier 42 is connected to the reference voltage Vref3. The voltage in which the output voltage at the switching circuit 14 (the voltage at both ends of the capacitor 15) is reduced by the voltage detecting unit 3 is fed into the negative terminal of the error amplifier 42.

The current detecting comparator 41 compares the signal fed into the negative terminal with the signal fed into the positive terminal. The current detecting comparator 41 supplies the H-level signal when the voltage at the positive terminal is larger than the voltage at the negative terminal, and the current detecting comparator 41 supplies the L-level signal when the voltage at the positive terminal is smaller than the voltage at the negative terminal. The signal supplied from the current detecting comparator 41 is fed into the OR gate 44. The voltage into which the current passed through the switch 14b of the switching circuit 14 is converted is fed into the positive terminal of the current detecting comparator 41. The output signal of the error amplifier 42 is fed as the reference voltage into the negative terminal of the current detecting comparator 41.

The Q2 terminal of the flipflop 40 is connected to the gate terminal of the switch 14b of the switching circuit 14.

The flipflop 40 is reset when the current passed through the switch 14b of the switching circuit 14 becomes the reference value or more. The L-level signal is supplied from the Q2 terminal of the flipflop 40 to turn off the switch 14b of the switching circuit 14.

As illustrated in FIG. 9, the fifth embodiment differs from the fourth embodiment in that the output of the OR gate 44 is connected to the reset terminal of the flipflop 40. The OR gate 44 performs a logical addition operation of the output of the current detecting comparator 41, the output of the Q1 terminal of the flipflop 39, and an output pulse of the timer 43.

An operation of the timer 43 will be described. The timer 43 becomes an active state when the ft-level signal is supplied from the QN1 terminal of the flipflop 39, and the timer 43 supplies the pulse signal after a constant time elapses since the signal of the QN1 terminal is switched from the L-level signal to the H-level signal, that is, since the switch 14b is turned on. The constant time is lengthened in proportion to the voltage applied to the timer 43, that is, the output voltage at the voltage detecting unit 3. When the L-level signal is supplied from the QN1 terminal, the timer 43 becomes a sleep state, and the timer 43 does not supply the pulse signal.

The pulse signal supplied from the timer 43 is used as the signal fed into the reset terminal of the flipflop 40, so that so-called soft start in which the output voltage is gradually raised may be performed in starting up the converter power-supply apparatus 30. As a result, the excessive load caused by the overcurrent passed through the component (transformer 14a, switch 14b, and diode 14c) of the switching circuit 14 and the generation of the acoustic noise caused by the rapid change in current passed through the coil may be prevented in the start-up.

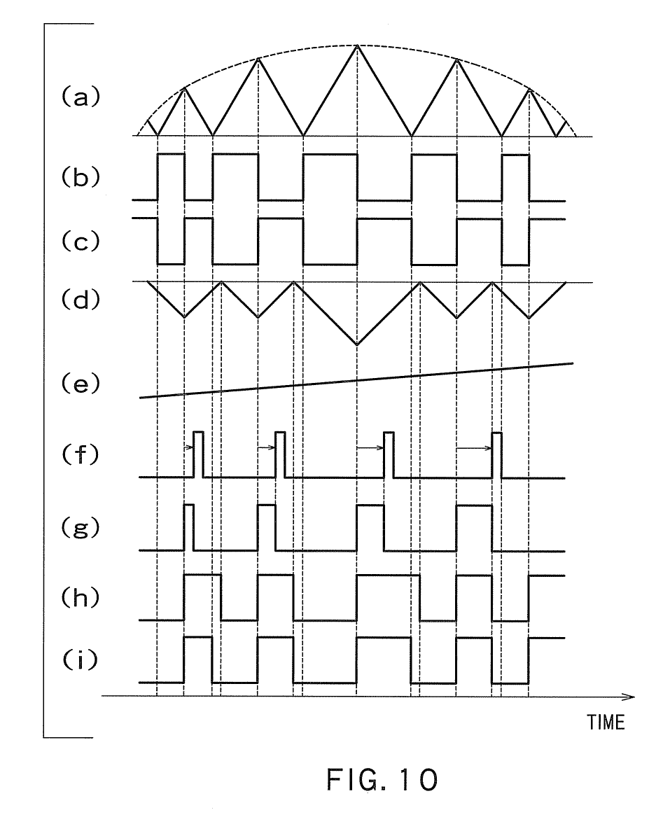

An operation in the start-up will be described with reference to a timing chart of FIG. 10. FIG. 10 is a timing chart illustrating an operation of the converter power-supply apparatus 30.

FIG. 10(a) illustrates a waveform of the current Iin12 fed into the switching circuit 12. FIG. 10(b) illustrates a waveform of the signal supplied from the Q1 terminal of the flipflop 39. FIG. 10(c) illustrates a waveform of the signal supplied from the QN1 terminal of the flipflop 39. FIG. 10(d) illustrates a waveform of the current Iin14 fed into the switching circuit 14.

FIG. 10(e) illustrates a waveform of the voltage in which the output voltage of the switching circuit 14 is reduced by the voltage detecting unit 3, that is, a waveform of the voltage applied to the timer 43.

FIG. 10(f) illustrates a pulse signal supplied from the timer 43 to the OR gate 44. As can be seen from FIG. 10(f), a time until the pulse signal is supplied since the signal from the QN1 terminal rises is lengthened as the voltage applied to the timer 43 is increased.

FIG. 10(g) illustrates a waveform of the signal supplied from the Q2 terminal of the flipflop 40. As can be seen from

FIG. 10(g), a width of the pulse supplied from the Q2 terminal at the timing of the pulse signal supplied from the timer 43 is gradually spread.

FIGS. 10(h) and 10(i) illustrate comparative examples of FIG. 10(g). FIG. 10(h) illustrates an output signal of the Q2 terminal when both the output of the timer 43 and the output of the Q1 terminal are not connected to the OR gate 44, that is, when only the output of the current detecting comparator 41 is connected to the reset terminal of the flipflop 40 like the fourth embodiment. FIG. 10(i) illustrates an output signal of the Q2 terminal when the output of the timer 43 is not connected to the OR gate 44. In the case of FIG. 10(i), the output signal of the Q2 terminal falls at the timing at which the output signal of the Q1 terminal rises in addition to the timing at which the current detecting comparator 41 supplies the H-level signal. In the fifth embodiment, as described above, the output signal of the Q2 terminal is set so as to have the pulse width proportional to the output voltage of the converter power-supply apparatus 30. Therefore, harmful phenomena such as the overcurrent and the acoustic noise may be reduced in the start-up of the converter power-supply apparatus 30 or the rapid change in load. Although the pulse width control is generally realized using a triangular waveform of the oscillator, advantageously the necessity of oscillator is eliminated in the fifth embodiment.

Incidentally, the following problem is generated when the switch 12b is turned on while the switch 14b is turned on. Because the current supplied from the switching circuit 12 is stopped although the switching circuit 14 tries to supply the current, the current passed through the switch 14b does not reach the reference value, and the switch 14b remains turned on. At this point, when the switch 12b is turned off to restart the supply of the current from the switching circuit 12, the current is rapidly passed through the switch 14b. Consequently, as with the case of the start-up, possibly the overcurrent is passed through the component of the switching circuit 14 or the acoustic noise of the coil is generated.

In the fifth embodiment, the output signal of the Q1 terminal of the flipflop 39 is fed into the OR gate 44. The flipflop 40 is reset to turn off the switch 14b at the timing at which the output signal of the Q1 terminal rises, so that the overcurrent passed through the component of the switching circuit 14 and the generation of the acoustic noise caused by the rapid change in current passed through the coil may be prevented. Therefore, the excessive operation of the switching circuit 14 is eliminated by providing the upper limit in the pulse width of the output signal of the Q2 terminal, thus the stable performance can be obtained.

Note that, in the fifth embodiment, the OR gate 44 performs the logical addition operation of the three outputs, that is, the output of the current detecting comparator 41, the output of the timer 43, and the output at the Q1 terminal of the flipflop 39. Alternatively, the OR gate 44 may perform the logical addition operation of any combination. For example, the OR gate 44 may perform the logical addition operation of the output of the current detecting comparator 41 and the output of the timer 43, or the OR gate 44 may operate the logical addition operation of the output of the current detecting comparator 41 and the output at the Q1 terminal of the flipflop 39.

In the fifth embodiment, as described above, the compactness and lengthened lifetime of the smoothing capacitor can be achieved by decreasing the voltage ripple generated at both ends of the smoothing capacitor, and therefore the compactness and lengthened lifetime of the power-supply apparatus can be achieved. The PWM control is performed to the switching circuit at the subsequent stage independently of the switching circuit at the preceding stage. Therefore, the PWM control functions such as the stability of the output voltage and the prevention of the overcurrent can sufficiently be exerted. The reverse recovery current of the diode is suppressed by the critical conduction mode to obtain the high-efficiency converter power-supply apparatus.

Further, the rapid change in switching pulse width is suppressed in the PWM control, and the upper limit of the pulse width is provided. Therefore, the harmful phenomena such as the acoustic noise of the coil and the excessive load applied to the component of the switching circuit can be prevented during the start-up and the fluctuation in load, and the power-supply apparatus that exerts the stable performance can be obtained.

### SIXTH EMBODIMENT

A converter power-supply apparatus 50 according to a sixth embodiment of the invention will be described below. The converter power-supply apparatus of the sixth embodiment has a point different from the converter power-supply apparatuses of the fifth embodiment. That is, the converter power-supply apparatus of the sixth embodiment includes two switching circuits connected in parallel, and the number of operated switching circuits is dynamically increased and decreased according to the load. Therefore, as with the first to third embodiments, the efficient operation may be performed in the wide range of load. Particularly, the electric power saving can be achieved during the light load.

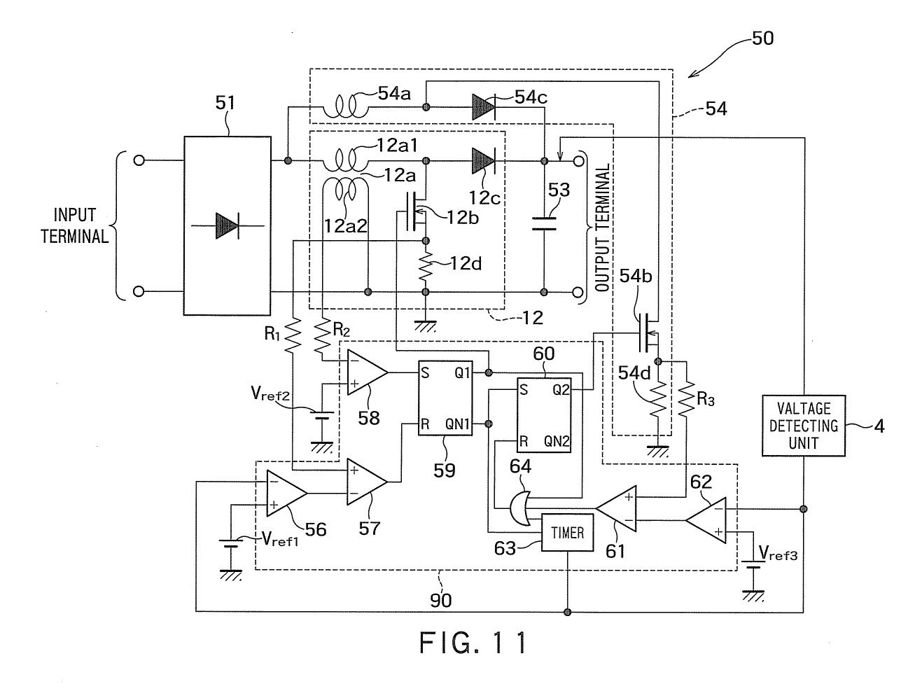

FIG. 11 illustrates a configuration of a converter power-supply apparatus 50 of the sixth embodiment. Referring to FIG. 11, the converter power-supply apparatus 50 includes the rectifier 11, the switching circuit 12, a capacitor 53, a switching circuit 54, and a power-supply control device 90.

Each component of the converter power-supply apparatus 50 will be described below. The detailed description of the component described in the fourth and fifth embodiments will not be repeated.

The rectifier 51 includes a full-wave rectifying circuit. The rectifier 51 causes the voltage applied from the external commercial alternating-current source to pulsate, and the rectifier 51 supplies the pulsating voltage to the switching circuits 12 and 54.

The switching circuit 54 includes a coil 54a, a switch 54b, a diode 54c, and a resistor 54d. For example, as illustrated in FIG. 11, the switch 54b is an n-type MOSFET. The switching circuit 12 and the switching circuit 54 are connected in parallel.

The capacitor 53 is a smoothing capacitor that is connected to the output ends of the switching circuits 12 and 54. The charges (electric energy) supplied from the switching circuits 12 and 54 are accumulated in the capacitor 53.

The switching circuits 12 and 54 and the capacitor 53 constitute a boost converter. The boost converter boosts the pulsating voltage, which is produced by the rectifier 51 based on the commercial alternating-current source, to a desired direct-current voltage.

Referring to FIG. 11, the power-supply control device 90 includes error amplifiers 56 and 62, current detecting comparators 57 and 61, a zero-current detecting comparator 58, flipflops 59 and 60, a timer 63, and an OR gate 64.

The error amplifier 56 amplifies and supplies a difference between inputs of a positive terminal and a negative terminal. The positive terminal of the error amplifier 56 is connected to the reference voltage Vref1. The voltage in which the voltage at both ends of the capacitor 53 is reduced by a voltage detecting unit 4 is fed into the negative terminal of the error amplifier 56. The voltage detecting unit 4 reduces the output voltage at both ends of the capacitor 53 to specification ranges (for example, 5 V or less) of the input terminals of the error amplifiers 56 and 62 using a unit such as a resistance voltage divider.

The current detecting comparator 57 compares the voltage fed into the negative terminal with the voltage fed into the positive terminal. The current detecting comparator 57 supplies the H-level signal when the voltage at the positive terminal is larger than the voltage at the negative terminal, and the current detecting comparator 57 supplies the L-level signal when the voltage at the positive terminal is smaller than the voltage at the negative terminal. The signal supplied from the current detecting comparator 57 is fed into the reset terminal of the flipflop 59. The voltage into which the current passed through the switch 12b of the switching circuit 12 is converted is fed into the positive terminal of the current detecting comparator 57. The signal based on the output voltage at the error amplifier 56 is fed as the reference voltage into the negative terminal of the current detecting comparator 57. More particularly, as described in the fourth embodiment, the signal in which the waveform information on the voltage supplied from the rectifier 51 is mixed in the output signal of the error amplifier 56 is fed into the negative terminal of the current detecting comparator 57.

As apparent from the above configuration, the flipflop 59 is reset when the current passed through the switch 12b of the switching circuit 12 becomes the reference value or more. The reference value depends on the output voltage at the switching circuit 12, and the reference value is decreased with increasing output voltage.

The output terminal of the zero-current detecting comparator 58 is connected to the set terminal of the flipflop 59. The positive terminal of the zero-current detecting comparator 58 is connected to the reference voltage Vref2. The negative terminal of the zero-current detecting comparator 58 is connected to the secondary winding 12a2 of the coil 12a through the resistor R2, and the voltage into which the current passed through the secondary winding 12a2 is converted is fed into the negative terminal of the zero-current detecting comparator 58. The zero-current detecting comparator 58 supplies the H-level signal to set the flipflop 59 when the current passed through the secondary winding 12a2 of the coil 12a becomes equal to or lower than the constant value determined by the reference voltage Vref2, as apparent from the above configuration. The reference voltage Vref2 is a sufficiently small value. Therefore, the zero-current detecting comparator 58 supplies the H-level signal when the current passed through the coil 12a becomes substantially zero.

The Q1 terminal of the flipflop 59 is connected to the gate terminal of the switch 12b of the switching circuit 12.

With this configuration, the H-level signal is supplied from the Q1 terminal to turn on the switch 12b, when the current passed through the secondary winding 12a2 of the coil 12a is equal to or lower than the constant value determined by the reference voltage Vref2 of the zero-current detecting comparator 58, that is, when the current passed through the secondary winding 12a2 of the coil 12a becomes substantially zero. On the other hand, the L-level signal is supplied from the Q1 terminal to turn off the switch 12b when the current passed through the switch 12b is larger than the reference value based on the output of the error amplifier 56. The control of the switching circuit 12 is the power factor improving control called the critical conduction mode like the fourth embodiment. In the critical conduction mode, the reverse recovery current passed through the diode 12c is decreased. Therefore, the high-efficiency operation can be achieved.

A stage subsequent to the converter power-supply apparatus 50 of the sixth embodiment will be described below.

The switching control (PWM control) is performed to the switching circuit 54 using the output signal at the Q2 terminal of the flipflop 60.

The set terminal of the flipflop 60 is connected to the QN1 terminal of the flipflop 59. The flipflop 60 is set at the timing at which the output of the QN1 terminal becomes the H-level signal, that is, at the timing at which the output of the Q1 terminal becomes the L-level signal, and the H-level signal is supplied from the Q2 terminal. The Q2 terminal of the flipflop 60 is connected to the gate terminal of the switch 54b of the switching circuit 54. The switch 54b is turned on when the H-level signal is supplied from the Q2 terminal, and the switch 54b is turned off when the L-level signal is supplied from the Q2 terminal. Therefore, the switch 54b of the switching circuit 54 is turned on at the timing at which the switch 12b of the switching circuit 12 is turned off.

Control in which the switch 54b of the switching circuit 54 is turned off will be described below.

The error amplifier 62 amplifies and supplies a difference between inputs of a positive terminal and a negative terminal. The positive terminal of the error amplifier 62 is connected to the reference voltage Vref3. The voltage in which the output voltage at the boost converter (the voltage at both ends of the capacitor 53) is reduced by the voltage detecting unit 4 is fed into the negative terminal of the error amplifier 62.

The current detecting comparator 61 compares the voltage fed into the negative terminal with the voltage fed into the positive terminal. The current detecting comparator 61 supplies the H-level signal when the voltage at the positive terminal is larger than the voltage at the negative terminal, and the current detecting comparator 61 supplies the L-level signal when the voltage at the positive terminal is smaller than the voltage at the negative terminal. The signal supplied from the current detecting comparator 61 is fed into the OR gate 64. The voltage into which the current passed through the switch 54b of the switching circuit 54 is converted is fed into the positive terminal of the current detecting comparator 61. The output signal of the error amplifier 62 is fed as the reference voltage into the negative terminal of the current detecting comparator 61. Alternatively, as with the current detecting comparator 57, the signal in which the waveform information on the voltage supplied from the rectifier 51 is mixed in the output signal of the error amplifier 62 may be fed into the negative terminal of the current detecting comparator 61.

The Q2 terminal of the flipflop 60 is connected to the gate terminal of the switch 54b of the switching circuit 54. The switch 54b is turned on when the H-level signal is supplied from the Q2 terminal, and the switch 54b is turned off when the L-level signal is supplied from the Q2 terminal.

As apparent from the configuration, the flipflop 60 is reset when the current passed through the switch 54b, that is, the current fed into the switching circuit 54 becomes equal to or more than the reference value. The L-level signal is supplied from the Q2 terminal of the flipflop 60 to turn off the switch 54b of the switching circuit 54.

As illustrated in FIG. 11, in the sixth embodiment, as with the OR gate 44 of the fifth embodiment, the output of the OR gate 64 is connected to the reset terminal of the flipflop 60. The OR gate 64 performs the logical addition operation of the output of the current detecting comparator 61, the output at the Q1 terminal of the flipflop 59, and the output pulse of the timer 63. The operation of the timer 63 is identical to that of the timer 43 of the fifth embodiment.

In the sixth embodiment, as with the fifth embodiment, the width of the pulse supplied from the Q2 terminal is proportional to the output voltage, and the upper limit of the pulse width is provided. Therefore, the harmful phenomena such as the acoustic noise of the coil and the excessive load applied to the component of the switching circuit can be prevented during the start-up of the converter power-supply apparatus 50 and the fluctuation in load to obtain the stable performance. Alternatively, as with the fourth embodiment, only the output of the current detecting comparator 61 may be fed into the reset terminal of the flipflop 60 while the OR gate 64 is not provided.

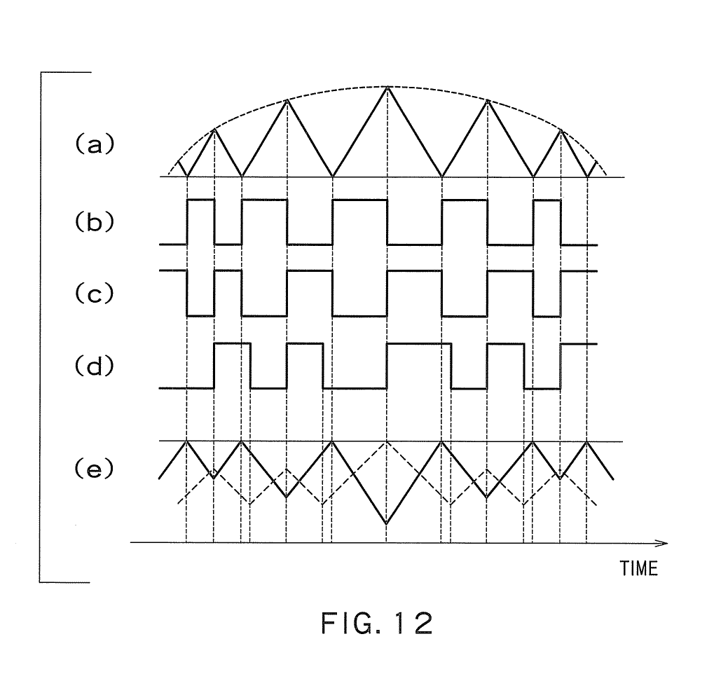

An operation of the converter power-supply apparatus 50 in the steady state, that is, the state in which the signals are not fed into the OR gate 64 from the Q1 terminal and timer 63 will be described with reference to a timing chart of FIG. 12. FIG. 12 illustrates a timing chart of the converter power-supply apparatus 50.

FIG. 12(a) illustrates a waveform of the current Iin12 fed into the switching circuit 12. FIG. 12(b) illustrates a waveform of the signal supplied from the Q1 terminal of the flipflop 59. FIG. 12(c) illustrates a waveform of the signal supplied from the QN1 terminal of the flipflop 59.

FIG. 12(d) illustrates a waveform of the signal supplied from the Q2 terminal of the flipflop 60. As can be seen from FIGS. 12(d) and 12(e), the output signal of the Q2 terminal rises at the timing at which the output signal of the Q1 terminal falls, and the output signal of the Q2 terminal falls at the timing at which the current Iout54 supplied from the switching circuit 54 is lowered to a predetermined value.

FIG. 12(e) illustrates a waveform of the current Iout12 (solid line) supplied from the switching circuit 12 and a waveform of the current Iout54 (broken line) supplied from the switching circuit 54. The sum of the current Iout12 and the current Iout54 becomes the current fed into the capacitor 53. As can be seen from FIG. 12(e), the current ripple generated at both ends of the capacitor 53 is suppressed because the current Iout12 and the current Iout54 have the substantially reversed phases.

A fundamental difference between the converter power-supply apparatus 50 of the sixth embodiment and the well-known interleave system will be described below. In the interleave system, as described above, the two switching circuits are alternately switched. Therefore, the control of one of the switching circuits depends on the other switching circuit. On the other hand, in the sixth embodiment, although the timing at which the switch 54b is turned on depends on the control of the switching circuit 12, the timing at which the switch 54b is turned off is independent of the switching circuit 12 except for the case in which the width of the pulse supplied from the Q2 terminal reaches the upper limit. Therefore, the converter power-supply apparatus 50 of the sixth embodiment is fundamentally different from the well-known interleave system.

Due to the feature, in the converter power-supply apparatus 50 of the sixth embodiment, the switching circuit 54 can be operated or stopped at any timing regardless of the operation of the switching circuit 12. That is, the switching circuit 54 may be operated like the expansion switching circuit (switching circuit 130) of the first embodiment. More specifically, both the switching circuit 12 and the switching circuit 54 may be operated when the load connected to the output terminal is larger than a predetermined amount. On the other hand, when the load is equal to or smaller than the predetermined amount, only the switching circuit 12 is operated while the switching circuit 54 is stopped. Note that, for example, the determination of the load amount is made by comparing the output voltage detected by the voltage detecting unit 4 with a predetermined value.

There are some methods for operating and stopping the switching circuit 54 according to the load.

For example, when the load is smaller than the predetermined amount, the flipflop 59 may be configured so as not to supply the H-level signal from the QN1 terminal. Therefore, the flipflop 60 is not set, and the switching circuit 54 is stopped.

In another method, when the load is smaller than the predetermined amount, the flipflop 60 may be configured so as to stop the operation of the flipflop 60. Therefore, the H-level signal is not supplied from the Q2 terminal of the flipflop 60, and the switching circuit 54 is stopped.

In still another method, the control signal switch may be used like the first embodiment. That is, the control signal switch corresponding to the control signal switch 152 of the first embodiment is provided between the Q2 terminal of the flipflop 60 and the gate terminal of the switch 54b. The comparison circuit corresponding to the comparison circuit 156 of the first embodiment is also provided. The comparison circuit compares the output voltage reduced by the voltage detecting unit 4 with a predetermined voltage to supply the H-level signal or L-level signal to the control signal switch. The on/off control is performed to the control signal switch based on the output of the comparison circuit. Therefore, as with the first embodiment, when the load is smaller than the predetermined amount, the control signal switch turns off to stop the switching circuit 54. The control signal switch 1 may be provided between the QN1 terminal of the flipflop 59 and the set terminal of the flipflop 60.

Therefore, the converter power supply having the high efficiency in the wide range of load is obtained like the first to third embodiments.

In the sixth embodiment, as described above, the PWM control of the switching circuit 54 is performed independently of the switching circuit 12. Therefore, the PWM control functions such as the stability of the output voltage and the prevention of the overcurrent can sufficiently be exerted. The reverse recovery current of the diode is suppressed by the critical conduction mode to obtain the high-efficiency converter power-supply apparatus.

Further, the rapid change in switching pulse width is suppressed in the PWM control, and the upper limit of the pulse width is provided. Therefore; the harmful phenomena such as the acoustic noise of the coil and the excessive load applied to the component of the switching circuit can be prevented during the start-up and the fluctuation in load. As a result, the power-supply apparatus that exerts the stable performance can be obtained.

Further, the number of operated switching circuits is dynamically increased and decreased according to the load to obtain the converter power-supply apparatus that is efficiently operable in the wide range of load. Particularly the switching loss may largely be reduced during the light load.

The six embodiments of the invention are described above. In the fourth to sixth embodiments, the critical conduction mode is adopted as the power factor improving control. Alternatively, the current discontinuous mode may be adopted as the power factor improving control.

Additional advantages and modifications will readily occur to those skilled in the art. Therefore, the invention in its broader aspects is not limited to the specific details and representative embodiments shown and described herein.

Accordingly, various modifications may be made without departing from the spirit or scope of the general inventive concepts as defined by the appended claims and their equivalents.

What is claimed is:

1. A power-supply control device that controls a boost converter, the boost converter including a basic switching circuit, an expansion switching circuit that is connected in parallel with to the basic switching circuit, and a capacitor that smoothes output voltages of the basic switching circuit and the expansion switching circuit,
the power-supply control device comprising:
a control circuit that respectively supplies a control signal to the basic switching circuit and the expansion switching circuit through a basic switching circuit signal line and an expansion switching circuit signal line, a switch of the basic switching circuit and a switch of the expansion switching circuit being turned on and off by the control signal;
a detecting unit that detects a voltage and/or a current in at least one of an input point of the boost converter, an input point of the basic switching circuit, an input point of the expansion switching circuit, and an output point of the boost converter;
a comparison circuit that compares a value detected by the detecting unit with a reference value, the comparison circuit supplying a first signal when a load connected to an output terminal of the boost converter is not lower than a predetermined amount, the comparison circuit supplying a second signal when the load is lower than the predetermined amount; and
a control signal switch that is provided in the expansion switching circuit signal line, the control signal switch connecting the expansion switching circuit signal line when receiving the first signal, the control signal switch disconnecting the expansion switching circuit signal line when receiving the second signal.

2. The power-supply control device according to claim 1, wherein the control circuit supplies the control signal for turning on the switch of the basic switching circuit at a timing at which a basic switching circuit input current becomes lower than a predetermined current amount, the basic switching circuit input current being detected in the input point of the basic switching circuit by the detecting unit, and
the control circuit supplies the control signal for turning off the switch of the basic switching circuit at a timing at which the basic switching circuit input current becomes not lower than the predetermined current amount.

3. The power-supply control device according to claim 2, wherein the predetermined current amount is zero.

4. The power-supply control device according to claim 1, wherein the control circuit turns on and off the switch of the basic switching circuit using a signal having a predetermined frequency, the signal being supplied from an OSC circuit.

5. The power-supply control device according to claim 1, wherein the reference value is based on a voltage generated by a voltage generating circuit.

6. A power-supply apparatus comprising:
a rectifier that causes a voltage applied from an external alternating-current source to pulsate;
the boost converter that boosts the pulsating voltage supplied from the rectifier; and
the power-supply control device according to claim 1.

7. The power-supply apparatus according to claim 6, further comprising a DC-DC converter that is connected to a stage subsequent to the boost converter,
wherein the control circuit performs PWM control of the DC-DC converter such that an output voltage at the DC-DC converter becomes a predetermined value, and
the comparison circuit compares a reference current with the boost converter output current detected in the output point of the boost converter by the detecting unit, and the comparison circuit supplies one of the first signal and the second signal based on the comparison result.

8. A power-supply control device that turns on and off a first switch and a second switch to control a boost converter and a second switching circuit, the boost converter including a first switching circuit that has the first switch and a capacitor that smoothes an output voltage at the first switching circuit, the second switching circuit having the second switch, the second switching circuit being series-connected to the boost converter, the second switching circuit receiving an output of the capacitor,
the power-supply control device comprising:
a PFC control circuit that performs on/off control of the first switch such that the first switching circuit performs a power factor improving operation in a discontinuous conduction mode or a critical conduction mode; and
a PWM control circuit that performs on/off control of the second switch to perform PWM control of the second switching circuit, the PWM control circuit turning on the second switch using a signal supplied from the PFC control circuit when the PFC control circuit turns off the first switch, whereby part of electric energy released from the first switching circuit is caused to flow in the second switching circuit, the PWM control circuit turning off the second switch to decrease the current flowing in the second switching circuit when an input current to the second switching circuit exceeds a reference value, the reference value being determined according to an output voltage at the second switching circuit.

9. The power-supply control device according to claim 8, further comprising a timer that supplies a pulse signal to the PWM control circuit to turn off the second switch after a time proportional to the output voltage at the second switching circuit elapses since the second switch is turned on.

10. The power-supply control device according to claim 9, wherein the PWM control circuit turns off the second switch at a timing at which the first switch is turned on.

11. The power-supply control device according to claim 8, wherein the PWM control circuit turns off the second switch at a timing at which the first switch is turned on.

12. A power-supply apparatus comprising:
a rectifier that causes a voltage applied from an external alternating-current source to pulsate;
the boost converter that boosts the pulsating voltage supplied from the rectifier;
the second switching circuit that steps down an output voltage at the boost converter to a desired voltage; and
the power-supply control device according to claim 8.

13. The power-supply apparatus according to claim 12, wherein the power-supply control device further includes a timer that supplies a pulse signal to the PWM control circuit to turn off the second switch after a time proportional to the output voltage at the second switching circuit elapses since the second switch is turned on.

14. The power-supply apparatus according to claim 13, wherein the PWM control circuit of the power-supply control device turns off the second switch at a timing at which the first switch is turned on.

15. The power-supply apparatus according to claim 12, wherein the PWM control circuit of the power-supply control device turns off the second switch at a timing at which the first switch is turned on.

16. A power-supply control device that performs on/off control of a first switch and a second switch to control a boost converter, the boost converter including a first switching circuit that has the first switch, a second switching circuit that has the second switch, the second switching circuit being connected in parallel with the first switching circuit, and a capacitor that smoothes outputs of the first and second switching circuits,
the power-supply control device comprising:
a PFC control circuit that performs the on/off control of the first switch such that the first switching circuit performs a power factor improving operation in a discontinuous conduction mode or a critical conduction mode; and
a PWM control circuit that performs the on/off control of the second switch to perform PWM control of the second switching circuit, the PWM control circuit turning on the second switch using a signal supplied from the PFC control circuit when the PFC control circuit turns off the first switch, the PWM control circuit turning off the second switch when an input current to the second switching circuit exceeds a reference value, thereby decreasing a current flowing in the second switching circuit, the reference value being determined according to an output voltage at the boost converter, the PWM control circuit stopping the on/off control of the second switch when a load connected to the output terminal of the boost converter is lower than a predetermined amount.

17. The power-supply control device according to claim 16, wherein the PFC control circuit does not supply a signal for turning on the second switch to the PWM control circuit when the load connected to the output terminal of the boost converter is lower than the predetermined amount.

18. The power-supply control device according to claim 16, wherein the PWM control circuit stops an operation thereof when the load connected to the output terminal of the boost converter is lower than the predetermined amount.

19. The power-supply control device according to claim 16, further comprising:
a comparison circuit that compares the load connected to the output terminal of the boost converter with the predetermined amount, the comparison circuit supplying a first signal when the load is not lower than the predetermined amount, the comparison circuit supplying a second signal when the load is lower than the predetermined amount; and
a control signal switch that is provided in a control signal line, the control signal line being used to perform the on/off control of the second switch, the control signal switch connecting the control signal line when receiving the first signal, the control signal switch disconnecting the control signal line when receiving the second signal.

20. A power-supply apparatus comprising:
a rectifier that causes a voltage applied from an external alternating-current source to pulsate;
the boost converter that boosts the pulsating voltage supplied from the rectifier; and
the power-supply control device according to claim 16.
